(19) United States
(12) Patent Application Publication
(10) Pub. No.: US 2005/0103689 A1
(43) Pub. Date: May 19, 2005

(54) Sealing screen assemblies and vibratory separators

(76) Inventors: David L. Schulte JR., Willis, TX (US); Jeffrey E. Walker, Houston, TX (US); George A. Burnett, Aberdeen (GB); Guy L. McClung III, Spring, TX (US); Thomas C. Adams, Hockley, TX (US); Haynes B. Smith, Kingwood, TX (US); James Adams, Conroe, TX (US); Charles Newton Grichar, Houston, TX (US); Kerry Ward, Cypress, TX (US); Kenneth W. Seyffert, Houston, TX (US)

Correspondence Address: Guy McClung, PMB 347, 16690 Champion Forest Drive, Spring, TX, 77379-7023, US

(21) Appl. No.: 10/923,252

(22) Filed: Aug. 20, 2004

Related U.S. Application Data
(63) Continuation-in-part of application No. 10/764,348, filed on Jan. 23, 2004.
Application No. 10/764,348 is a continuation-in-part of application No. 10/762,768, filed on Jan. 22, 2004.
Application No. 10/764,348 is a continuation-in-part of application No. 10/050,690, filed on Jan. 16, 2002.
Application No. 10/764,348 is a continuation-in-part of application No. 10/053,350, filed on Jan. 16, 2002, now Pat. No. 6,662,952.
Application No. 10/764,348 is a continuation-in-part of application No. 10/057,755, filed on Jan. 23, 2002, now Pat. No. 6,769,550.
Application No. 10/764,348 is a continuation-in-part of application No. 10/050,690, filed on Jan. 16, 2002.
Application No. 10/764,348 is a continuation-in-part of application No. 10/037,474, filed on Oct. 19, 2001, now Pat. No. 6,669,985.
Application No. 10/764,348 is a continuation-in-part of application No. 10/429,264, filed on May 2, 2003.
Application No. 10/764,348 is a continuation-in-part of application No. 10/429,290, filed on May 2, 2003.

(51) Int. Cl. B07B 1/28; B07B 1/49

(52) U.S. Cl. 209/405; 209/309

(57) ABSTRACT

A screen assembly, a vibratory separator with such a screen assembly and methods of its use, the screen assembly, in certain aspects, having a frame with a first frame end spaced apart from a second frame end by two opposed spaced-apart sides including a first side and a second side, screening material on the frame, a plurality of crossmembers spaced apart and extending from the first side to the second side, each crossmember of the plurality of crossmembers connected to the first side and the second side, and each crossmember of the plurality of crossmembers having at least one series of openings therethrough; in one particular aspect the frame having crossmembers located to facilitate sealing of the support against screen assembly mounting structure of a vibratory separator; and methods for using such frames and such screen assemblies.

### BACKGROUND OF THE INVENTION

1. Field of the Invention

The present invention is directed to screen assemblies, seals for them, support structures for them, vibratory separators or shakers that use them, and methods of their use.

2. Description of Related Art

The prior art discloses a wide variety of vibrating screens, devices which use them, shale shakers, and screens for shale shakers and vibratory separators. The screens catch and remove entrained solids from fluid [e.g., but not limited to, removing entrained solids from drilling fluid circulated through a wellbore during drilling operations], as it passes through them.

Various prior art screens have one, two or more overlying layers of screening material, mesh, and/or screen cloth which may be secured, glued or bonded together. A support or series of supports is often used beneath the screen or screens of many prior art screen assemblies. Also an outer frame is used in many screens. The frame may include one or more crossmembers extending across the frame and connected at the ends to sides of the frame. Frame members and other solid cross support members can block fluid flow and adversely affect screen performance. Many of the frames or supports for screen mesh used in screen assemblies are made of metal or other relatively heavy material. Handling of such heavy members can be difficult and fatiguing.

### SUMMARY OF THE PRESENT INVENTION

The present invention discloses, in at least certain embodiments and certain aspects, a screen assembly for mounting on mounting structure or deck of a vibratory separator or shale shaker, the screen assembly having a frame with a first frame end spaced apart from a second frame end by two opposed spaced-apart sides including a first side and a second side, the frame having a top and a bottom, the frame abutting the mounting structure or deck at a mounting-structure/frame interface, screening material on the frame, and seal apparatus on the frame for sealing the mounting-structure/frame interface.

The present invention, in at least certain aspects, provides a screen assembly frame which uses cross supports with a series of openings spaced apart along their length. In one particular aspect these opening are a series of triangular openings so that the support member has a truss-like configuration with sufficient strength to support the screen mesh or meshes on the screen assembly. In certain aspects such a truss-like configuration requires a minimum of metal or other structural material. In one aspect side portions with a recess therein are folded so that part of a crossmember is received within the recess. In certain aspects, material and fluid is flowable through the openings in the crossmembers.

In one embodiment the present invention discloses a screen assembly with a frame that has a series of recesses and openings along sides thereof. In one particular aspect, cut out portions of the sides alternate with openings so that no opening is directly adjacent a cut out portion.

In one aspect the present invention provides a screen assembly in which screen mesh material is supported by a wire truss support rather than a support plate or tubular frame. In one particular aspect, the wire truss support is a grid of wire support members and, optionally, some or all of the wire support members act as springs beneath the screen mesh.

The present invention, in certain aspects, discloses methods for mounting a screen assembly to a screen mounting structure of a vibratory separator to facilitate sealing of an interface between the screen assembly and the screen mounting structure, the method including locating the screen assembly on the screen mounting structure so that all crossmembers of a support supporting screening material of the screen assembly are all either generally transverse to or all generally parallel to the a direction of material flow from one side of the screen assembly to the other, or at least two exterior sides of the support are independent along their entire lengths without connection between an exterior side and a crossmember that extends across the support parallel to the side (i.e., there may be one or more transverse crossmembers extending between two longitudinal crossmembers, but such transverse crossmembers do not connect with the exterior sides of the support), and forcing first and second sides of the support down with crowning apparatus to effect crowning of the screen assembly, third and fourth sides (the sides which have no connection to the transverse crossmembers) which are at right angles to the first and second sides rigid yet sufficiently flexible so that with the screen assembly in a crowned configuration the third side and the fourth side each along substantially all of the length thereof sealingly contact a surface of the screen mounting structure, In certain embodiments of the present invention a screen assembly is disclosed in which a honeycomb structure serves as a support member for screen mesh material.

It is, therefore, an object of at least certain preferred embodiments of the present invention to provide new, useful, unique, efficient, non-obvious screen assemblies for vibratory separators and vibratory separators with one or more such screen assemblies;
Such screen assemblies with one or more support members with a series of openings through a main body part;
Such screen assemblies with a series of spaced-apart generally triangular opening in a truss-like configuration;
Such screen assemblies with frame parts having a series of cut out portions and a series of openings and, in one aspect, no opening adjacent a cut out portion;
Such screen assemblies which have relatively less material than certain prior art screen assemblies, yet which are sufficiently strong and stable for effective use;
Such screen assemblies with a wire grid for supporting screen mesh material; and
Such screen assemblies with one or more spring members in a support for screening material.

The present invention recognizes and addresses the previously-mentioned problems and long-felt needs and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

### DESCRIPTION OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or equivalent embodiments.

FIG. 1A is a top view of a screen support according to the present invention in a screen assembly according to the present invention. FIG. 1B is an side cross-sectional view of the screen support of FIG. 1A. FIG. 1C is a top view of a crossmember of the screen support of FIG. 1A. FIGS. 1C-1E are top views of other forms of crossmembers according to the present invention. FIG. 1F is a side view of a crossmember according to the present invention.

FIG. 2A is a top view of a screen support according to the present invention for a screen assembly according to the present invention. FIG. 2B is a perspective view of the screen support of FIG. 2A. FIG. 2C is a side cross-sectional view of the screen support of FIG. 2A in a screen assembly according to the present invention.

FIG. 3A is a bottom view of a screen support according to the present invention for a screen assembly according to the present invention. FIG. 3B is a side view of the screen support of FIG. 3A. FIG. 3C is an end view of the screen support of FIG. 3A.

FIG. 4A is a top unfolded view of a screen according to the present invention (without showing the screening material—see FIG. 4C). FIG. 4B is a side view in cross section of part of the screen of FIG. 4C. FIG. 4C is a partial side view of the screen of FIG. 4A. FIG. 4D is an end of part of the screen of FIG. 4C. FIG. 4E is a partial bottom view of the screen of FIG. 4C. FIG. 4F is a partial bottom perspective view of the screen of FIG. 4C. FIG. 4G is a side view of a crossmember of the screen of FIG. 4C. FIG. 4H is a partial bottom view of the screen of FIG. 4C.

FIG. 5 is a perspective view of a screen support according to the present invention in a screen assembly according to the present invention.

FIG. 6A is a perspective view of a screen support according to the present invention in a screen assembly according to the present invention. FIG. 6B is a partial end cross-section view the screen support and screen assembly of FIG. 6A showing layers of screening material not yet secured.

FIG. 7A is a perspective view of a screen support according to the present invention. FIG. 7B is a side view of the screen support of FIG. 7A. FIG. 7C is a perspective view of part of the intermeshed wire of the screen support of FIG. 7A. FIG. 7D is a side view of a screen assembly according to the present invention.

FIGS. 8A and 8B are side cross-sectional views of screen supports according to the present invention.

FIG. 9A is a perspective exploded view of a screen support according to the present invention in a screen assembly according to the present invention. FIG. 9B is a top view a honeycomb support of the screen assembly of FIG. 9A.

FIG. 10 is a perspective view of a wire truss structure for a screen support according to the present invention.

FIG. 11 is a perspective view of a shale shaker according to the present invention.

FIG. 12 is a top view of a prior art support for a screen assembly.

FIG. 13A is a perspective view of a screen assembly support according to the present invention. FIG. 13B is a side view and FIG. 13C is and end view of the support of FIG. 13A.

FIGS. 14A-19 are perspective views of screen assemblies according to the present invention.

FIGS. 20A and 20B are cross-sectional views of hollow tubular members for supports according to the present invention.

FIGS. 21A and 21B are side views of part of a tubular member of a support according to the present invention. FIG. 21C is a cross-sectional view along line 61C-61C of FIG. 21B.

FIG. 22 is a perspective view of support according to the present invention.

FIG. 23A is a top perspective view of a design for a support according to the present invention. FIG. 23B is a bottom view, FIG. 23C is a side view, FIG. 23D is a side view (side opposite the side shown in FIG. 23C), FIG. 23E is an end view, and FIG. 23F is an end view (end opposite the end shown in FIG. 23E) of the support of FIG. 23A.

FIG. 24 is a side schematic cross-section view of a shale shaker with screen assemblies according to the present invention.

FIG. 25A is a top perspective view of a design for a support according to the present invention. FIG. 25B is a bottom view, FIG. 25C is a side view, FIG. 25D is a side view (side opposite the side shown in FIG. 25C), FIG. 25E is an end view, and FIG. 25F is an end view (end opposite the end shown in FIG. 25E) of the support of FIG. 25A.

FIG. 26 is a top view of a screen assembly support according to the present invention (bottom view is the same).

FIG. 27A is a bottom view of a support for a screen assembly according to the present invention. FIG. 27B is a cross-section view along line 27B-27B of FIG. 27A.

FIG. 28 is a partial bottom view of a screen assembly support according to the present invention.

FIGS. 29A, 29B, and 29C are cross-section views of screen assembly supports according to the present invention.

FIGS. 30A and 30B are side cross-section views of seals according to the present invention in seal holders according to the present invention.

FIGS. 31A-31D are side cross-section views of seal structures according to the present invention.

FIG. 32A is a top view of a screen assembly according to the present invention. FIG. 32B is a bottom view of the screen assembly of FIG. 32A. FIG. 32C is an end view and FIG. 32D is a side view of the screen assembly of FIG. 32A.

FIG. 33 is a perspective view of a shaker according to the present invention.

FIG. 34 is a cross-section view of a seal member according to the present invention on a frame member.

### DESCRIPTION OF EMBODIMENTS PREFERRED AT THE TIME OF FILING FOR THIS PATENT

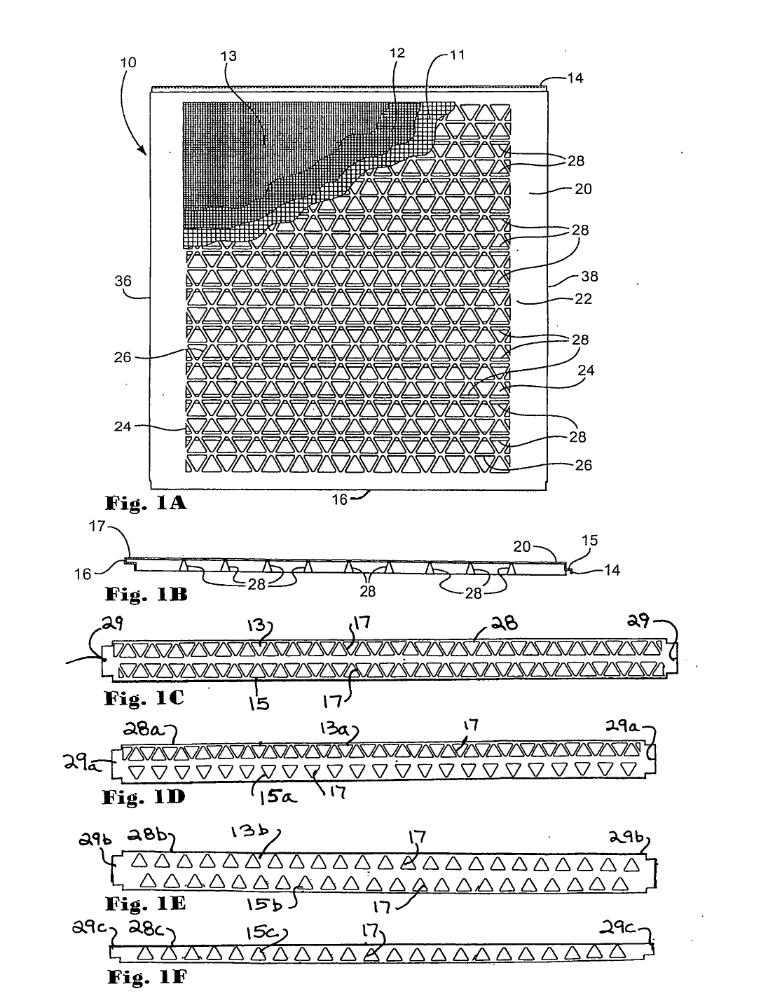

FIGS. 1A, 1B, and 1C illustrate a screen assembly 10 according to the present invention with a support structure 20 according to the present invention. The screen assembly 10 has, optionally, three layers 11, 12, 13 of screening material bonded to a top surface 22 of the structure 20. Preferably, the layers 11, 12, 13 are also bonded together over substantially their entire surface area.

A plurality of openings 24 through the structure 20 define a plurality of support members 26. To the underside of the unibody structure 20 are connected a plurality of spaced-apart ribs 28 which, in one aspect are welded to a metal structure 20, each rib with series 13, 15 of spaced-apart triangular openings 17 with adjacent triangular openings inverted with respect to each other. In this particular embodiment the ribs 28 are positioned along a substantial majority of their length directly beneath one of the support members 26 that extend across a major portion of the structure 20; but it is within the scope of this invention to position them anywhere on the underside of the structure 20. The structure 20 has spaced-apart sides 36, 38.

As shown in FIG. 1B, the screen assembly 10 has an end 14 and a “ledge” end 16. The ledge end has an upper ledge portion 17 that rests on a shoulder 15 of an end 14 of an adjacent screen. Thus one screen end 16 seals against another screen end 14 when such screens are used end-to-end.

The structure 20 is, initially, a single integral piece of material in which the pattern of openings 24 is formed, e.g. by any suitable cutting tool, punch, laser, or plasma beam or arc. Alternatively, the area with the openings 24 may be removed so that all that is formed according to the present invention is a four-sided structure to which is applied one, two, three or more layers of screening sheet(s) and/or screening material; including but not limited to a perforated sheet or plate and/or any desired number of layers of screening material, bonded or unbonded.

FIG. 1C shows a rib 28 which has not yet been bent or folded into the form shown in FIG. 1B. Ends 29 may be introduced into corresponding holes or slots (not shown) in the sides 36, 38 to facilitate securement of the ribs.

It is within the scope of this invention for the screen assembly 10 to have none, one, two, three or more layers of screening material, i.e., screen, mesh, and/or cloth made, e.g., of stainless steel wire and/or plastic. Any such layer or combination of layers may be bonded together (glued, welded, and/or sintered) in any known manner and/or bonded to the unibody structure 20 in any known manner. Any such layer or layers of screening material may be substantially flat or may be undulating (with a series of alternating ridges and valleys) as is well known in the art. In one particular aspect the screen assembly 10 is like screen assemblies disclosed in U.S. Pat. No. 6,443,310 B1 issued Sep. 3, 2002, but with any or some of the present invention's teachings.

FIG. 11 shows a shale shaker S according to the present invention with one or more screen assemblies 8 according to the present invention which may be any screen assembly disclosed herein according to the present invention, including but not limited to those of FIGS. 1A, 2C, 3A, 4A, 5, 6A, 7D, 8A, 8D, and 9A. Any suitable known shaker or vibratory separator may employ one or more screens according to the present invention including but not limited to shakers as disclosed in U.S. Pat. Nos. 5,392,925; 6,601,709 B2; and 5,641,070 and in the references cited in each patent.

Edges on both sides of a structure 20 according to the present invention can form hook strips. In such an embodiment with hook strips a hook end (like the hook end 14) and/or a ledge end (like the ledge end 16) may be deleted.

FIGS. 1D-1F show alternative embodiments 28a, 28b, and 28c, respectively, for the support ribs 28. The support rib 28a has ends 29a and has a series 13a of openings like the series 13 in FIG. 1C; but every other opening 17 has been deleted from the series 15a as compared to the series 15 in FIG. 1D. The support rib 28b has two series of openings, 13b and 15b, each with every other opening 17 deleted as compared to the series 13 and 15, respectively, of FIG. 1C.

The support rib 28c of FIG. 1F is shown in a folded configuration (like the support ribs 28, FIG. 1B0. The support rib 28c has end 29c and only one series of openings 15c with openings 17. In one particular aspect the structure 20 is like the unibody structure 20 of U.S. Pat. No. 6,443,310 issued Sep. 3, 2002, incorporated fully herein for all purposes, but with the teachings of the present invention.

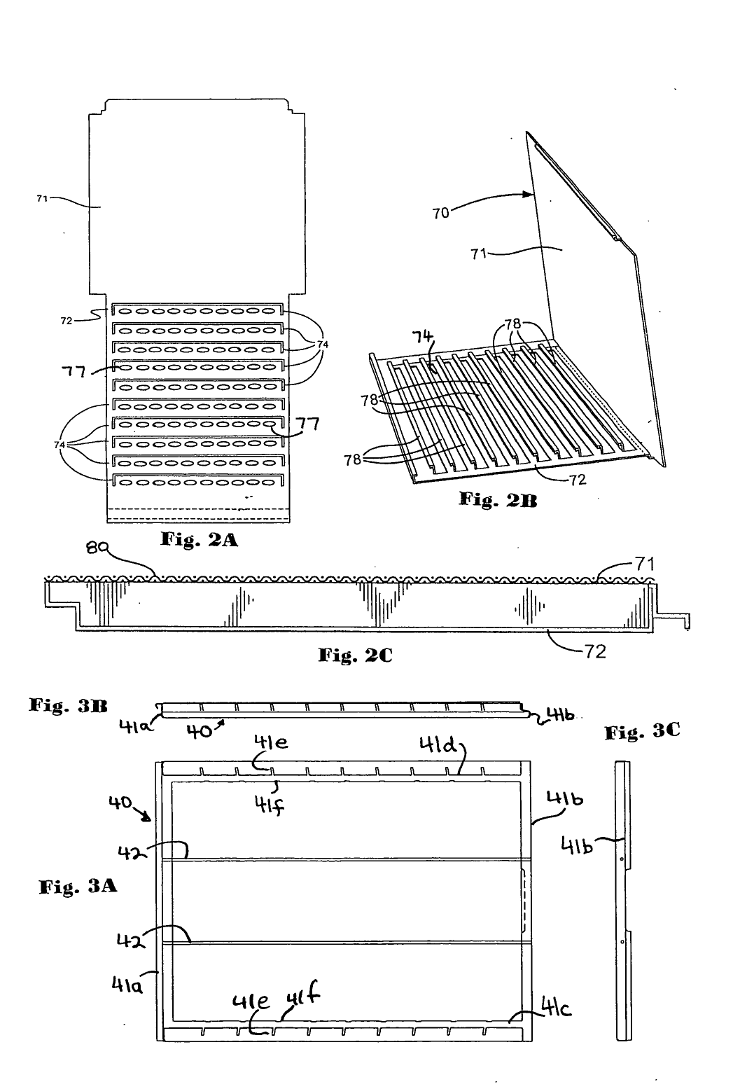

FIGS. 2A-2C illustrate a structure 70 according to the present invention that is initially a single integral piece of material that is cut or machined to the shape shown in FIG. 2A that includes a first portion 71 in which will be made an opening or a pattern of openings and a second portion 72 in which will be made a series of rib supports. As shown in FIGS. 2A and 2B a series of slots 74 are made (cut, drilled, punched, or machined in any suitable manner) in the second portion 72 and a plurality of series of openings 77.

A pattern of openings as desired may be made (cut, drilled, punched, or machined in any suitable manner) in the first portion 71, e.g., like the openings 24, FIG. 1A. These openings and their pattern may be any suitable shape opening in any desired pattern, including, but not limited to, any opening shape and pattern disclosed herein. The openings may be of such a size that no additional screening material is placed over them; or, alternatively, any screening material disclosed herein, bonded or unbonded, may be placed over the openings.

As shown in FIG. 2B rib supports 78 have been bent or folded away from the second portion 72. The first portion 71 has been folded or bent with respect to the second portion 72. The first portion 71 has been folded or bent over onto the second portion 72 so that an underside of the first portion 71 contacts top surfaces of the rib supports 78. The first portion 71 may be glued, bolted, screwed, or welded to top surfaces of the rib supports 78 [or Velcro™ material may be used to secure the portion 71 to the ribs 78]. FIG. 2C shows the structure of FIG. 2B with screening material 80 thereon. The screening material 80 may be, in at least certain preferred embodiments, any known screen, screens, mesh, and/or meshes in any known combination, bonded or unbonded to each other, bonded or unbonded to the top portion 71, and/or of different weaves or similar weaves. The ends 73, 75 correspond, respectively, to ends 14 and 16 of the screen of FIG. 1A and function similarly.

In one aspect the structure 70 is like the structure 70 of U.S. Pat. No. 6,443,310, but with the teachings of the present invention.

FIGS. 3A-3C show a screen assembly support 40 according to the present invention which has a metal frame 41 with two ends 41a, 41b, spaced apart by two sides 41c, 41d. Two metal rods 42 each have two ends, one end connected to each of the frame ends 41a, 41b. Opposed pairs of notches 41e and 41f facilitate emplacement and mounting of crossmembers (e.g., as in FIGS. 1C, 1E, or 1F) on the support 40.

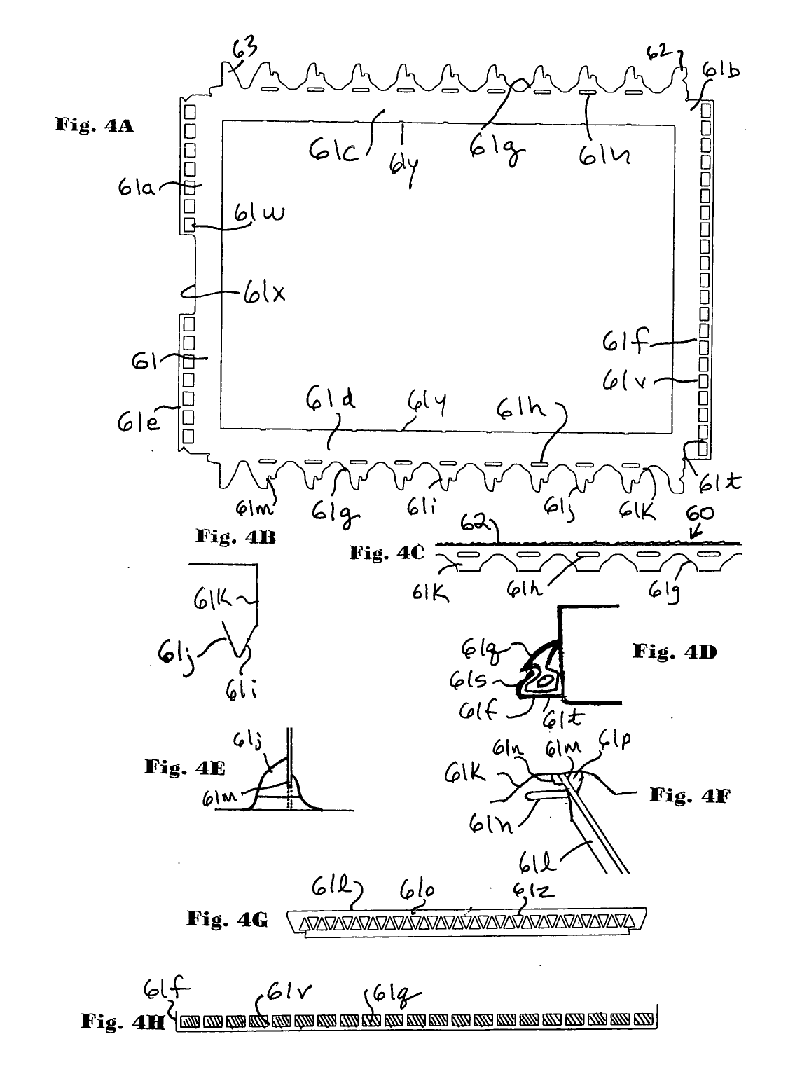

FIGS. 4A-4C illustrate a screen assembly 60 according to the present invention which has screening material 62 (see FIG. 4C; may be any layer or layers disclosed herein, referred to herein, or in a reference incorporated herein—as may be the case with any layer or screening material in any embodiment hereof) on a frame 61. The frame 61 has two ends 61a, 61b spaced apart by two sides 61c, 61d. The screening material 62 may be any screening material referred to or disclosed herein, with or without a perforated plate, backing cloth, or a coarse mesh layer. As shown in FIG. 4A, each end 61a, 61b has parts 61e, 61f each with a series of openings. Each side 61c, 61d has a series of recesses or cut outs 61g and, optionally, a series of openings 61h. Although the cut outs 61g and openings 61h may be any desired shape, any desired size, and at any desired location, as shown the openings 61h are not in line with (i.e., not above as shown in FIG. 4C) the cut outs 61g. Thus, looking along the length of a side 61c, 61d, the openings 61h are interspersed between the cut outs 61g.

FIG. 4B shows the configuration of the side 61c in cross-section upon folding of the material shown in FIG. 4A into its final position. Each side 61c has portions, 61i, 61j, and 61k, shown unfolded in FIG. 4A and folded in FIGS. 4B and 4E. Portion 61j has a recess 61m for receiving part of a crossmember 61n as shown in FIG. 4D. As shown in FIGS. 4E and 4F, upon folding of the portions 61i, 61j, and 61k, with a part of the crossmember in the recess 61m, a part 61n is on one side of the crossmember and a part 61p of the portion 61j is on the other side of the crossmember. The parts 61n and 61p are shown welded to the crossmember, but they may be connected, adhered, and/or welded to the crossmembers by any suitable connection, welding, and/or adhering technique, e.g., but not limited to with screws, nuts and bolts, epoxy adhesive, spot welding, “mig” welding, “tig” welding, and/or resistance welding. The crossmembers 61l may, optionally, have a structure as shown in FIG. 4G with a body 61o and openings 61z. As shown the crossmember has a truss-like structure with its openings 61z.

As shown in FIGS. 4D and 4H the part 61f of the screen assembly 60 has a seal 61q in a seal holder 61s. The seal 61q seals against an adjacent screen; e.g. an adjacent screen with an end like the ends 61e. Any suitable seal may be used [and, in one aspect, a seal as disclosed in U.S. Pat. No. 6,443,310 B1 issued Sep. 3, 2003; in U.S. application Ser. No. 10/359,733 filed Feb. 4, 2003; or in U.S. application Ser. No. 10/429,290 filed May 2, 2003; or in U.S. application Ser. No. 10/429,264 filed May 2, 2003-both said patent and all said applications incorporated fully herein for all purposes]. The seal holder 61s has a bottom surface 61t with a plurality of spaced-apart openings 61v which serve as openings or spaces into which part of the seal 61q may move or protrude serving then as holders for the seal 61q to help it remain in place within the seal holder 61s and to inhibit movement of the seal 61q within the seal holder 61s. Such openings 61v also facilitate insertion of a seal 61q into the seal holder 61s and help to accommodate seals that may not be made exactly to tolerance. Tabs 62 are folded to contact and connect to the seal holder 61r. Tabs 63 are folded to contact and connect to the end 61e. The end 61e has a plurality of spaced-apart openings 61w and a recess 61x for. In one aspect the screen assembly 60 has an end area pattern as disclosed in U.S. application Ser. No. 10/167,978 filed Jun. 12, 2002 and/or it may include a support as disclosed in U.S. Pat. No. 6,601,709 B2 issued Aug. 5, 2003, both said application and said patent incorporated fully herein for all purposes. A seal holder for the screen assembly support of FIG. 4A may have a structure as disclosed in U.S. application Ser. No. 10/429,290 filed May 2, 2003, but with the teachings of the present invention.

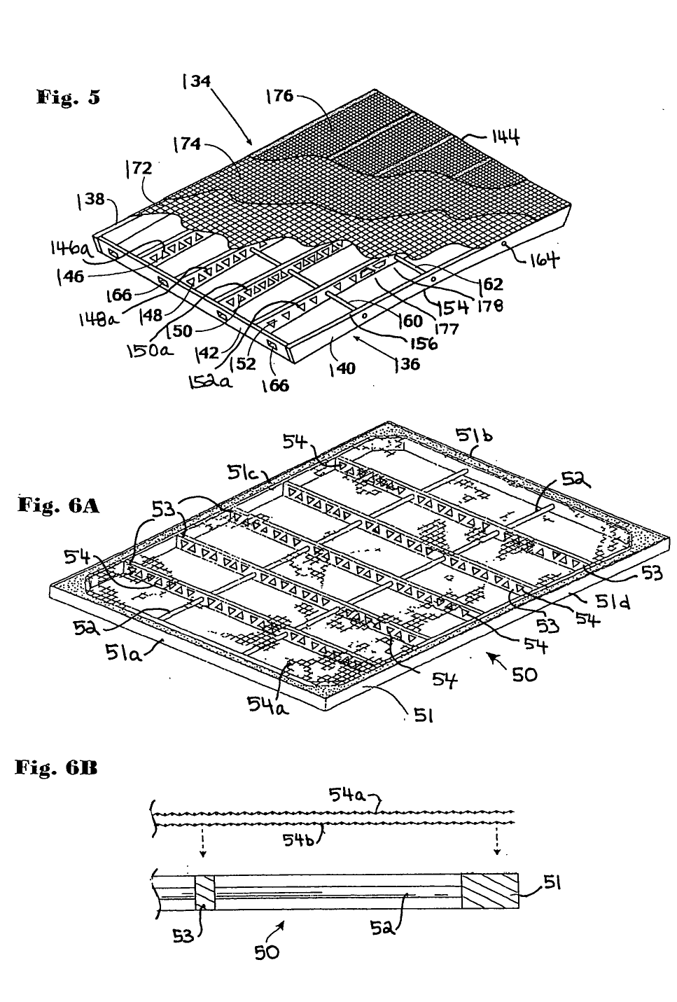

FIG. 5 illustrates one embodiment of a screen assembly 134 according to the present invention which has a plurality of screen cloths 172, 174, and 176 affixed to a top, planar side of a frame 136 and, optionally, tensioned thereon. The screen cloths are shown partially cut-away for clarity. Any known screening material, materials, mesh, meshes and/or multiple layers may be used; in one aspect a coarse backing layer 172 mates with the frame, a fine middle layer 174 is placed thereover, and a fine top layer 176 is on top. In one aspect the screen cloths are stretched and tensioned to the frame and then affixed with epoxy or other adhesive. Any desired number of screen cloths may be used according to the present invention.

The frame 136 is rigid and is a part of the screen assembly 134. The rigid frame may be a one piece, single, integral member or may be composed of various members configured together. The rigid frame may be fabricated from steel, aluminum, plastics, composites, rubbers and/or fiberglass and may be manufactured by various processes, such as by injection molding, compression molding or pultrusion.

The rigid frame 136 includes a pair of parallel, opposed sides 138 and 140 and a pair of parallel, opposed ends 142 and 144. The sides in the present embodiments are longer than the ends to form an elongated rectangle but it will be understood that other configurations, such as a square, are possible within the scope of the invention. A plurality of cross supports 146, 148, 150 and 152 extend between the ends 142 and 144 and are parallel to the sides 138 and 140. The number of cross supports will vary with the size and design and the invention is not limited to a particular number of cross supports.

The rigid frame 136, optionally, includes an underside 154 which is radiused or arched to match the radius of the crowned deck. Additionally, each of the cross supports has an underside which is arched or radiused. The rigid frame 136 also includes a top, planar side 156 which is opposed to the underside 154 of the frame. Alternatively, the underside 154 may also be flat and planar like the top 156.

A plurality of braces 160, 162 and 164 extend between the cross supports and between the cross supports and the opposed sides. The braces in the present embodiments are perpendicular to the sides and to the cross supports but might run at any desired angle or diagonally. The braces in the present embodiment are not flush with the top but could be.

A fastening mechanism is, optionally, provided to securely fasten the screen assembly to the vibrating shaker. Each of the frame ends 142 and 144 contain a plurality of slots 166 for attaching the screen assembly. Alternately, the slots 66 may take the form of notches (not shown) in the ends. The underside 54 of rigid frame 136 may be covered with a resilient material. In one aspect the screen assembly 134 is like the screen assembly 34 of U.S. Pat. No. 5,927,511, but with teachings of the present invention.

Each of the cross supports 146, 148, 150, 152 has a series of openings 146a, 148a, 150a, and 152a, respectively. As shown these openings are triangular, but they may be any desired shape. The triangular shape and alternate inverted triangular shapes result in a truss-like support member. The series of openings 152a has relatively fewer openings as compared to the series 146a, 148a and 150a. Optionally, openings may be used for any opening of any series of openings of any embodiment herein which have a generally trapezoidal shape, e.g. as openings 177 and 178. Any series of openings in any embodiment herein may be a series of trapezoidal openings and may, in one aspect, be a series with alternating trapezoidal shapes inverted.

FIGS. 6A and 6B show a screen assembly 50 according to the present invention which has a frame 51 with ends 51a, 51b spaced apart by opposed sides 51c, 51d. Rods 52 are connected to the ends 51a, 51b and extend through a plurality of crossmembers 53 which are connected to and between sides 51c, 51d. Screening material 54a and 54b (which may be like any layer or layers described or referred to herein) covers the frame 51.

Each crossmember 53 has a series of openings 54 therethrough which may be any desired size, shape and spacing. As shown the openings 54 are triangular with every other opening inverted (apex of a triangular shape pointed downwardly), thus forming a truss-like member of each crossmember 53.

In one aspect the screen assembly 50 is like the screen assembly 10 of U.S. Pat. No. 6,305,549, but with teachings of the present invention. As with the screen assembly 60, FIG. 4A, the screen assembly 134 or the screen assembly 50 (or any screen assembly according to the present invention) may have a series of spaced-apart openings in one or both ends and/or in one or both sides of a frame or other screening material support.

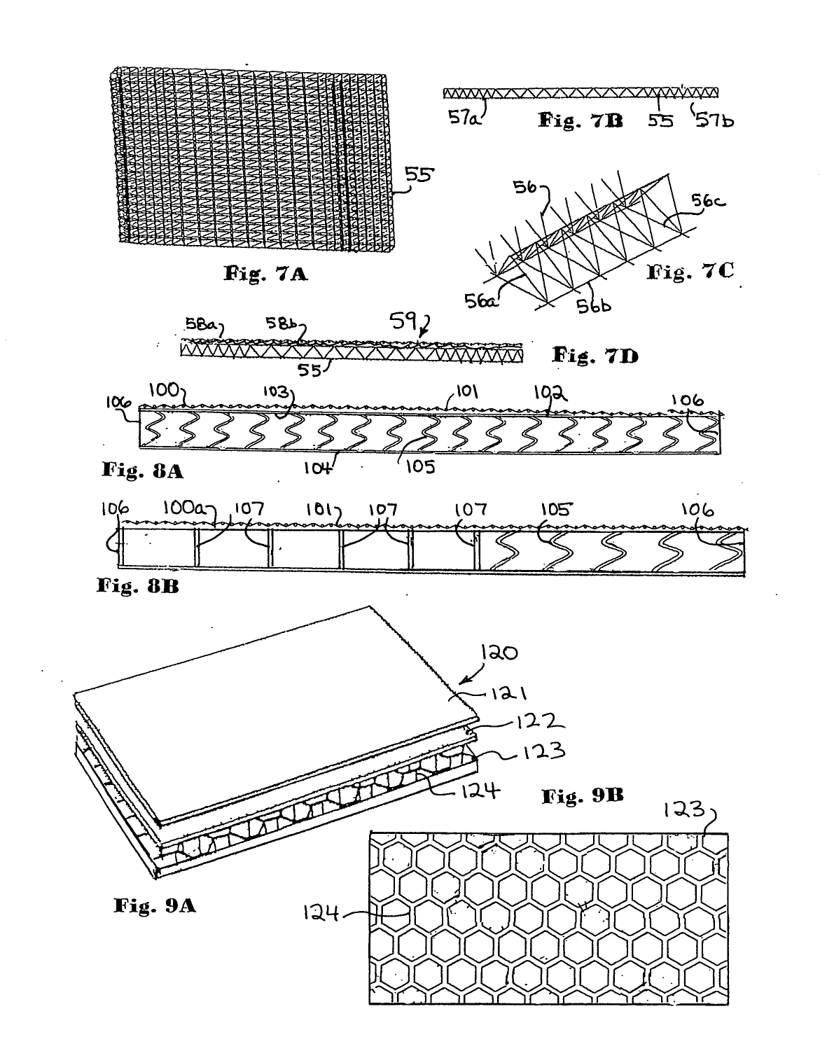

FIG. 7A shows a screen support 55 for a screen assembly according to the present invention. The screen support 55 is a grid of intermeshed wires 56 which form a plurality of triangular components 56a connected by connecting wires 56b and 56c (see FIG. 7C). Wires may be welded, sintered, and/or bonded together.

The screen support 55 may have a uniform density of wires through out or, as shown in FIGS. 7A and 7B, different parts of the grid may be of different wire densities. For example, but not by way of limitation, as shown in FIGS. 7A and 7B areas 57a and 57b have a denser wire grid structure. Such areas may be located at areas of increased wear; for example, areas of a screen assembly at which fluid to be treated is initially introduced or end exit areas.

FIG. 7D shows a screen assembly 59 according to the present invention with a screen support 55 with layers 58a, 58b, of screening material thereon which may be any screening material layer or layers described or referred to herein. Any suitable frame (not shown) may, optionally, be used with the screen assembly

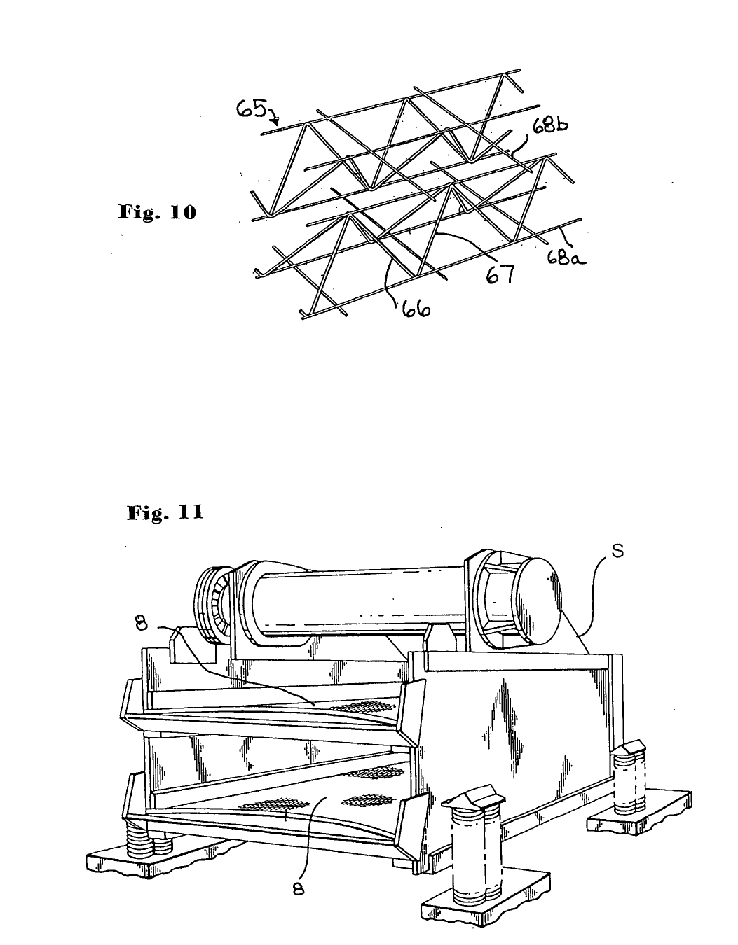

FIG. 10 shows an alternative configuration for a wire grid which may be used as a screen support for a screen assembly according to the present invention. A wire grid 65 has a plurality of wires 66 which form wire pyramids 67 connected by cross wires 68a and 68b. Alternating rows of pyramids 67 may, optionally, be inverted as shown in FIG. 10. Wires 66, 68a, and 68b may be welded, sintered and/or bonded together. A screen assembly with a wire grid 65 according to the present invention has screening material thereon like any shown or described herein. The wire grid 65 may be like that described in U.S. Pat. No. 4,614,013 or in any reference cited therein.

FIG. 8A shows a screen assembly 100 according to the present invention which has screening material 101 on a wire grid support 102. The screening material 101 may be any screening material layer or layers referred to or described herein. The wire grid support 102 has upper connecting wires 103 and lower connecting wires 104 between which are connected a plurality of spaced-apart wires springs 105. Any suitable wire spring may be used for the springs 105. The wires 103, 104 and wire springs 105 may be connected by welding, sintering, and/or bonding. End wires 106 connect the wire 103, 104 together. Any wire spring or plurality of them may be deleted and/or substituted therefor may be a non-spring wire or strip (which is also true for the screen assembly 100a).

FIG. 8B shows a screen assembly 100a, like the screen assembly 100 (and like numerals indicate like parts), but with a portion having connecting wires 107 that are not springs.

It is within the scope of this invention to provide on any wire grid screen support one, some, a portion of, or all wires beneath screening material which are wires springs. Also in addition to metal wire material, any wire of any embodiment herein may be made of suitable plastic, fiberglass, or composite.

FIG. 9A shows a screen assembly 120 according to the present invention which has two layers of screening material 121, 122 (shown schematically and spaced apart) and a screen support 123 which has a honeycomb structure 124 having a multiplicity of openings 124a therethrough. As shown in FIG. 9A the components of the screen assembly are spaced apart from each other, but it is to be understood that the screening material layers 121, 122 are connected to the screen support 123, e.g. but welding, gluing, sintering and/or bonding and that the layers 121, 122 may be any layer or layers referred to or described herein.

The screen support 123 (as may be any support according to the present invention) may be made of metal, e.g., but not limited to, steel or stainless steel, plastic, composite, or fiberglass; as may be any wire or spring of any support or grid according to the present invention.

FIG. 11 shows a shale shaker S with screen assemblies 8 mounted thereon. The screen assemblies 8 may be any screen assembly disclosed herein with any screen assembly support disclosed herein.

It has been recognized that in some vibratory separators employing screening assemblies employing supports (or frames) made of relatively rigid material (e.g., hollow tubular mild steel with a square cross-section and a side measuring about ¾″ with a wall thickness of about ⅛″″) that an effective seal between an edge or side of the support and part of a bed, basket or mounting structure of the vibratory separator is not achieved. In some aspects, two spaced-apart sides of a screen assembly are secured in place by edge mounting structure, wedge structures, or inflated bladders which push down on or wedge in the two spaced-apart sides. With a relatively rigid screen support, such mounting can result in insufficient flexing of the support so that sides of the support (not the sides contacted by the wedges or bladders) are not effectively sealed against the bed, etc., (or against a seal member on a bed, etc.) resulting in unsealed areas between the bed and the support through which pieces of drilled cuttings or other solids (which would normally move over and off the top of the screen assembly) can move, i.e., move through the open unsealed area (rather than as intended off the top of the screen for collection) and fall into a sump or reservoir (which is intended ideally to receive only filtered drilling fluid) from which they can be recycled back down into the wellbore negatively affecting drilling efficiency. One specific vibratory separator in which this problem may be encountered depending on the screen assemblies used is disclosed in U.S. Pat. No. 5,641,070 issued Jun. 24, 1997, incorporated fully herein for all purposes.

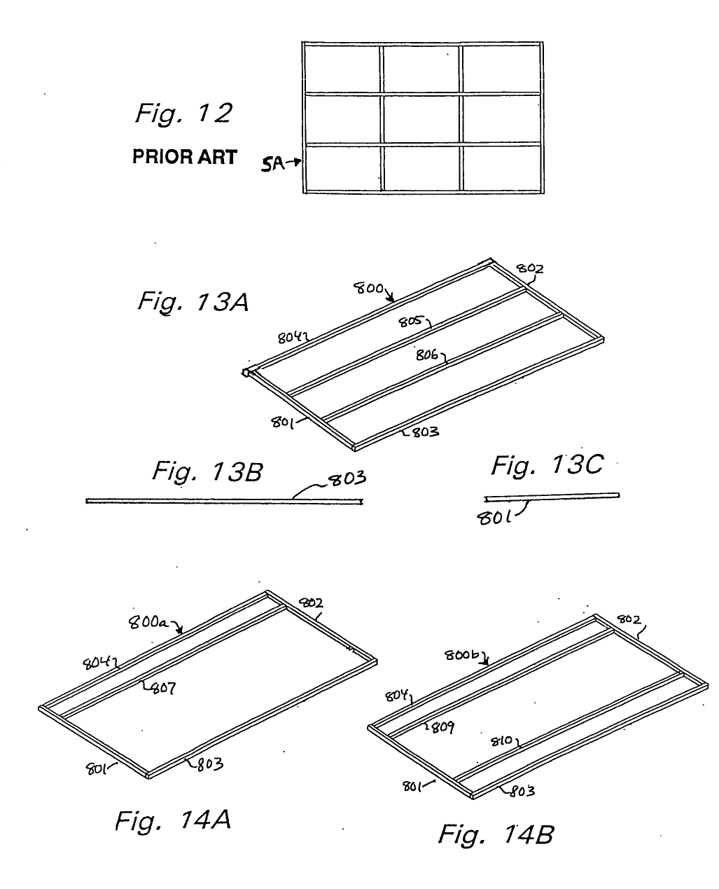

In one aspect this ineffective sealing problem is addressed according to the present invention by modifying a typical rigid prior art support for a screen assembly SA as shown in FIG. 12 by removing crossmembers shown in FIG. 12 that extend in one of two general directions between one or the other pair of two spaced-apart sides thereof, so that the remaining crossmembers are all positioned so that they lie generally in the direction of material flow on the screen assembly when it is in use on a vibratory separator or are all transverse to such flow direction; i.e., crossmembers are present in certain of the methods according to the present invention in only one direction, not both; and, in certain aspects, there are two, three, four, five, six or more of such crossmembers which, in one aspect, are equally spaced-apart across the screen assembly and from the sides thereof. It is to be understood that the structure shown in these figures may be modified so that there are any desired number of crossmembers and, in one particular aspect, two or five such crossmembers equally spaced-apart across the support.

FIGS. 13A-13C show a support 800 according to the present invention for a screen assembly according to the present invention (which may be, but is not limited to, any screen assembly according to the present invention disclosed or referred to herein and which may have on it any screening material referred to or disclosed herein). The support 800 has two spaced-apart sides 801, 802 and two spaced-apart sides 803, 804 (sides 801 and 802 identical; sides 803 and 804 identical). Extending from the side 801 to the side 802 are two crossmembers 805, 806. There are no crossmembers extending between the sides 803, 804. In one particular aspect all of the sides and crossmembers of the screen assembly are made from pieces of hollow mild steel with a square cross-section, a wall thickness of about one-eighth inch with a side about three-quarters of an inch long. In another aspect these pieces are solid (as may be the case with any support disclosed herein). The pieces are, in certain aspects, connected together by any known method, including but not limited to with fasteners, adhesives, and/or welding (e.g., “mig,” “tig,” or resistance welding) (as may be the case with any support and/or crossmember disclosed herein). In one particular aspect the screen assembly 800 is made of plastic, polymer and/or composite with or without strengthening metal rods and/or fibers therein (as may be the case with any support disclosed herein).

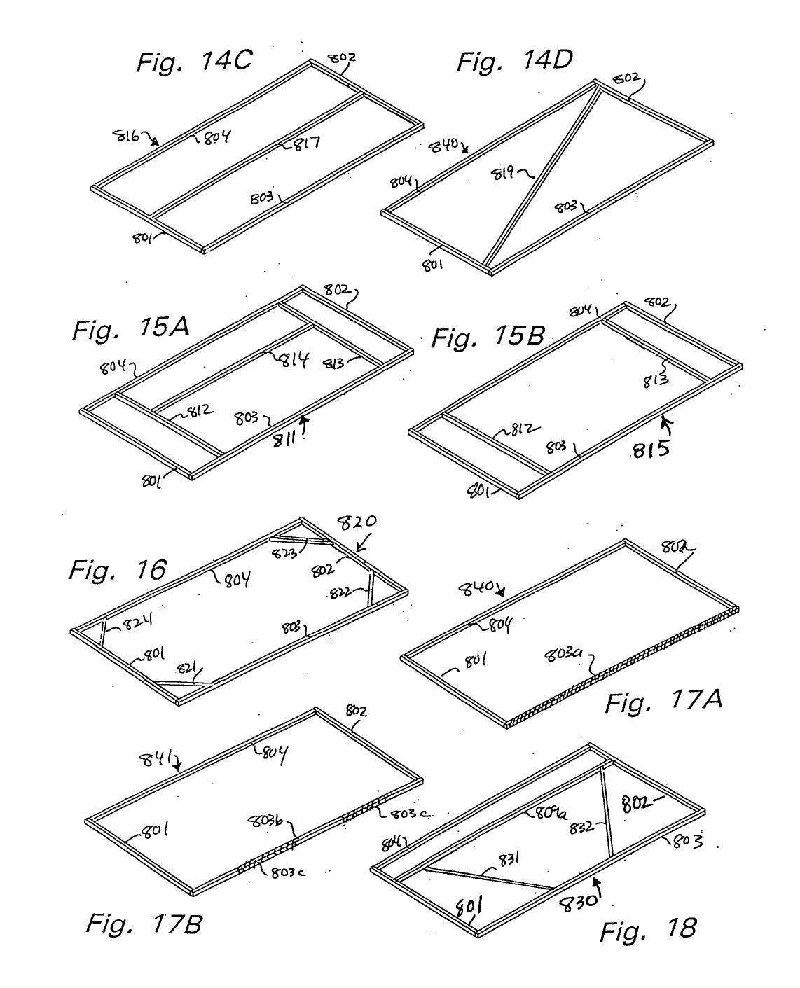

FIGS. 14A and 14B show alternative designs 800a and 800b of the screen assembly 800 of FIG. 12. In the screen assembly 800a like numerals indicate like parts; but instead of the crossmembers 805, 806, there is one crossmember 807 and it is closer to the side 804 than to the side 803 so that, in one aspect, in use the screen assembly may be positioned so that the side 803 is at a material exit end of a vibratory separator or at a material exit side of this particular screen assembly, while in another aspect this positioning is reversed and the side 804 is at the material exit end or side.

The screen assembly 800b, FIG. 14B, has no crossmembers 805, 806, but has two crossmembers 809, 810 each closer to a respective side 804, 803 than to a center of the screen assembly. FIG. 14C shows a screen assembly 816 (like the screen assembly 800 and like numerals indicate like parts) without crossmembers 805, 806; but with a single crossmembers 817 which may, according to the present invention, be located equidistant between the sides 803, 804.

The screen assembly 840, FIG. 14D, is like the screen assembly 800 (like numerals indicate like parts), but the crossmembers 805 and 806 are deleted and a crossmember 819 extends from the side 801 to the side 802 diagonally. It is also within the scope of the present invention for one end of the crossmember 819 to be connected to the side 803 or to the side 804, or for one end to be connected to the side 803 and one end connected to the side 804. It is also within the scope of the present invention to have two spaced-apart crossmembers 819 at the angle shown to the sides 101, 102 or at any desired angle, or they may crisscross across the support.

FIGS. 15A and 15B illustrate screen assemblies 811 and 815 which have sides 801-804 like the screen assembly 800, FIG. 13; but which have crossmembers 812, 813 between the sides 801, 802 (the crossmember 812, 813 like and connected to sides as the crossmembers 805, 806 except in length). The screen assembly 811 also has at least one crossmember 814 extending between and connected to the crossmembers 812, 813. It is within the scope of this invention for the crossmember 814 to be located as is any of the crossmembers 805, 806, 807, 809, or 810 with respect to the sides 803, 804.

FIG. 16 shows a screen assembly 820 with sides 801-804 (like in the screen assembly 800, FIG. 13); but with no crossmembers between either pair of sides. Instead, diagonal members 821-824 extend between and are each connected to two sides which are connected to each other (connected as any sides and crossmember are connected as disclosed herein). According to the present invention diagonal members 823, 824 or 821, 822 may be deleted; diagonal members 823, 821 or 824, 822 may be deleted; and the diagonal members may be any desired length. In certain aspects with respect to a screen assembly side (e.g. 803 or 804) which is to seal against screen mounting structure, the side having an entire length and a middle point, an end of the diagonal member (e.g. 823 or 824) is not within 10% of the length close to the middle point or, put another way, the end of the diagonal member is within 40% of the side to which its other end is connected; for example, in a screen assembly with such a side (e.g. 803 or 804) that is 50″ long, the diagonal member's end touching the 50″ long side is 10″ or more away from the middle of the 50″ long side. In one particular aspect a diagonal member (e.g. the diagonal member 824) is connected between the side 803 and the diagonal member 822 and/or the diagonal member 823 is connected between the diagonal member 821 and the side 803. Similarly, either or both diagonal members 821, 822 can be connected between a side and another diagonal member.

FIGS. 17A and 17B show, respectively, screen assemblies 840 and 841 according to the present invention which have sides 801, 802 and 804 as in the screen assembly 800, FIG. 13A but which have, instead of the side 803, a side 803a (FIG. 17A) or a side 803b (FIG. 17B). The side 803a is made of less rigid material than the side 803 and, in one aspect, of material less rigid than the other sides. In one particular aspect in which the sides 801, 802, and 804 are made of mild steel as described above, the side 803a is made of aluminum, fiberglass, plastic, polymer and/or composite with the same dimensions and shape but less rigid than the other sides, or, in one aspect, with the same outer measurements, but with a wall thickness sufficient to increase the side 803a's flexibility, and in particular aspect with a wall thickness of about one-tenth of an inch or less, and, in one aspect it may be made of aluminum with a wall thickness of about 0.080 inches. The side 803b has a portion 803c which is like the side 803a (in any of its possibilities) but which is only a portion of the side 803c, with end portions 803d like the side 803 (FIG. 13A) or like the sides 801-802 in material, shape, and cross-section.

A side 803a or 803b may be used in any screen assembly support according to the present invention; or it may be used in any known prior art screen assembly; and, in one aspect one or two such sides may be used with a screen assembly as shown in FIG. 12 or any known screen assembly with one or more crossmembers to be positioned so that they are generally aligned parallel with or generally transverse to a general direction of material flow when the screen assembly is in use on a vibratory separator or shale shaker.

A screen assembly 830 according to the present invention shown in FIG. 18 is like the screen assemblies of FIGS. 14A, and 16 (like numerals indicate like parts); but the screen assembly 830 has two diagonal members 831, 832 that each have one end connected to the side 803 and one end connected to a crossmember 809a (like the crossmember 809, FIG. 14A). Alternatively the crossmember 809a is deleted and the diagonal members are connected to the sides 801 (diagonal member 831) and 802 (diagonal member 832); or the crossmember 809a is deleted and the diagonal members are connected between the side 803 and the side 804 with the diagonal members not parallel to the sides 801, 802 (one such embodiment, screen assembly 830a, shown in FIG. 19).

It is within the scope of the present invention for the diagonal members to be at any angle to the sides 803, 804 (however, in certain aspects they are not parallel to the sides 801, 802).

Any of the supports according to the present invention disclosed in FIGS. 13A-26 may have any plate and/or backing cloth or coarse mesh connected thereto and any screening material disclosed or referred to herein, with the screening material on the plate, cloth, or mesh if one is present or, otherwise, directly on the support. Any support in FIGS. 13A-26 may have one or more holes for receiving fasteners according to the present invention as described above; and/or one or more holes for receiving a member projecting upwardly from the screen mounting structure as described above.

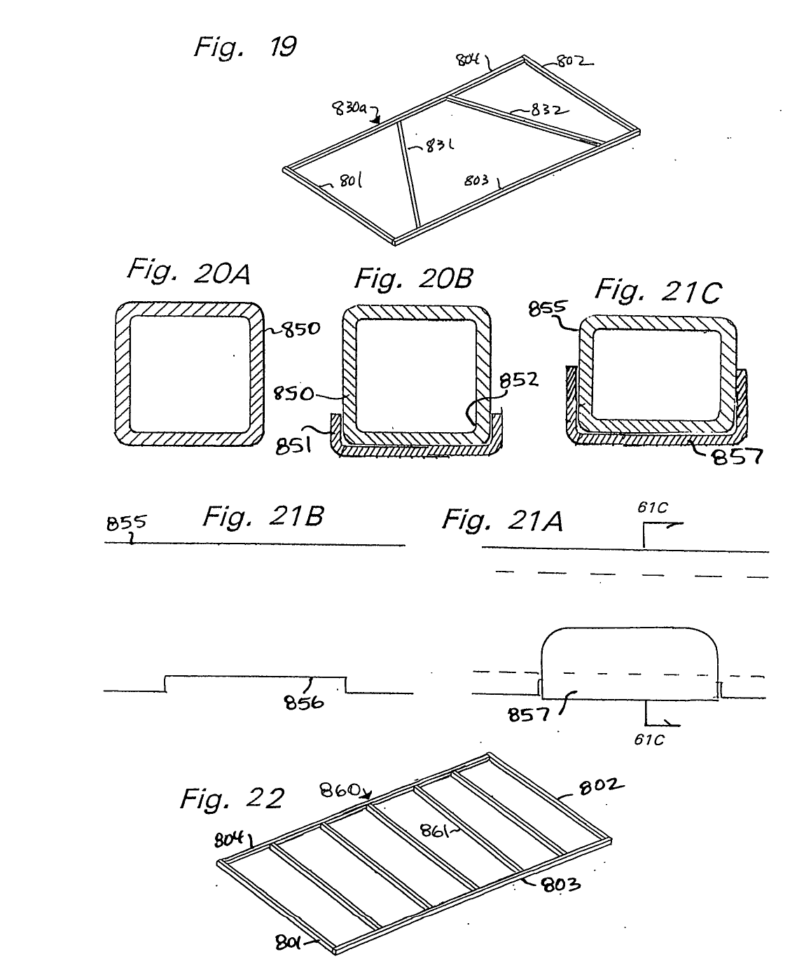

FIG. 20A shows in cross-section one embodiment for a hollow tubular member 850 which may be used for any side, end or crossmember of any embodiment described above. As shown in FIG. 20B, as desired a seal member 851 of any desired length may be releasably or permanently affixed to a lower part 852 of the member 850, e.g., with a push-on friction fit and/or with adhesive or glue. Such a seal member may be any desired thickness and may be used in discovered areas of actual ineffective sealing or applied to areas of anticipated ineffective sealing. In certain aspects a seal member like the seal member 850 may be provided in standard length and then cut to a desired length at a job site.

FIGS. 21A-21C show another embodiment of a hollow tubular member 855, like the tubular member 850, but with a recessed portion 856 for receiving part of a seal member 857 (like the seal member 851). One or more recessed portions 856 may be provided on any side or crossmember of any support described herein at anticipated locations of ineffective sealing or at discovered locations of ineffective sealing. Seal members 851 (and recessed portions 856) may be any desired length and, in one particular aspect, extend along substantially the entire length of a screen assembly's ends and sides.

FIG. 22 shows a design for a screen assembly support 860 according to the present invention which is similar to the support 800, FIG. 13A, but without the crossmembers 805, 806 and with five spaced-apart crossmembers 861 (like the crossmembers 812, 813, FIG. 15A). End and side views of the support 860 are like those views of the support 800 (see FIGS. 13B and 13C).

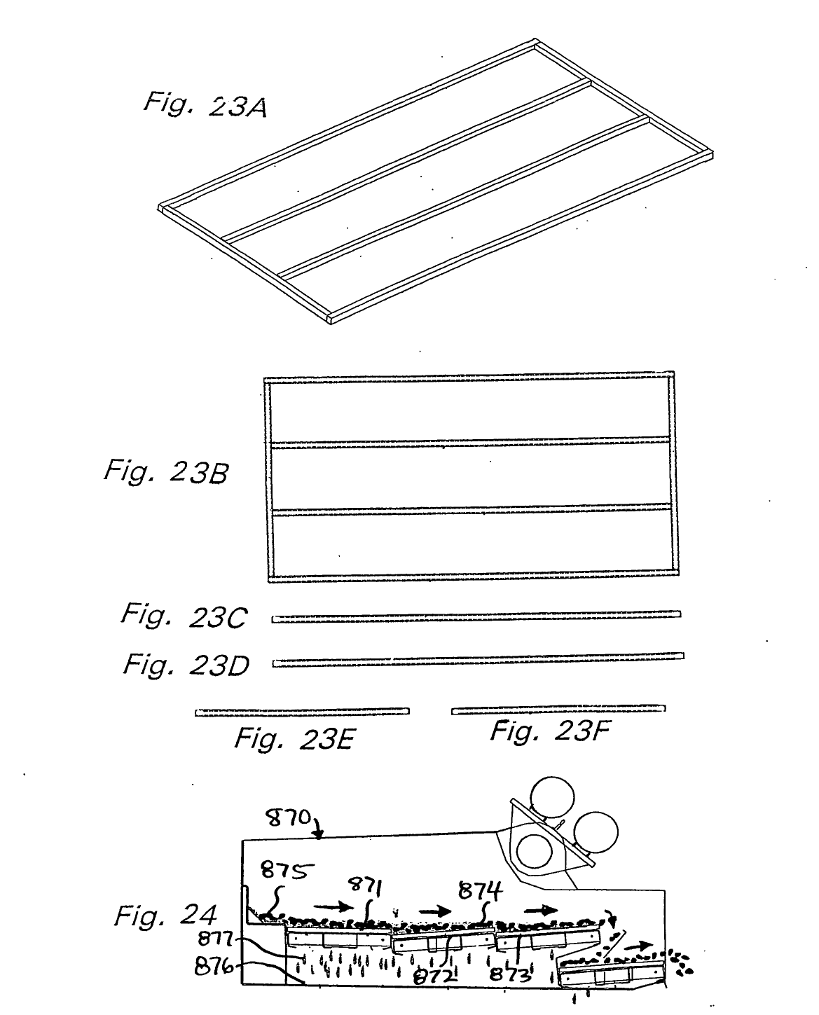

FIGS. 23A-23F show a design for a screen assembly support according to the present invention like the support 800, FIG. 13A. The ends and sides of the screen assembly shown in FIG. 23A are like those views of the screen assembly of FIG. 22.

FIG. 24 shows a Brandt King Cobra shale shaker 870 (commercially available from Brandt-Varco) with screen assemblies 871, 872, and 873 according to the present invention (which may be any screen assembly with any support according to the present invention with crossmembers located so that they are generally transverse to a direction of flow of material indicated by the arrows in FIG. 24, including, but not limited to the supports of FIGS. 13A and 23A). As shown by the arrows in FIG. 24, it is desirable that drilled solids 874, debris, etc. in drilling material 875 introduced to the shale shaker 870 for processing move on the tops of the screen assemblies 871, 872, 873 and that drilling fluid 877 filtered from the material 875 flow down into a sump 876. It is also desirable that as the solids, etc. move on top of the screens that, as viewed from above, the solids are uniformly and evenly distributed across the width of the screen assemblies. With a screen assembly with a prior art support as shown in FIG. 12 with crossmembers transverse to the length of the screen and crossmembers connecting between a screen side and a crossmember (crossmembers that in use would be generally parallel to the direction of material flow on the tops of the screen assemblies in FIG. 24), “dead zones” develop on top of the screen assemblies above the transverse crossmembers and solids do not move in these dead zones or do not move as readily in these dead zones, creating a relatively larger mass of solids that moves along areas of the tops of the screen assemblies not above these crossmembers resulting in a non-uniform flow of solids on the tops of the screens. When there are transverse crossmembers extending from one side of the support to the other, these dead zones can also extend from one side of the screen assembly to the other. Undesirable masses of solids in these dead zones, masses with more liquid in them than in material in adjacent areas on top of the screen assembly, may not have as much fluid removed from them if the dead zones were not present. By removing transverse crossmembers and using a support, e.g. as in FIGS. 13A and 23A or 25A or 26, the occurrence and/or size of these dead zones is reduced and greater processing efficiency is achieved. The relatively large masses of material moving on the top of a screen assembly with the prior art support can increase wear of the screen mesh and contribute to a shorter useful screen assembly life. If a screen assembly with the prior art support has these undesirable relatively large masses of solids moving on top of it, and the screen assembly is ineffectively sealed to the shaker's basket, deck, or bed for supporting screen assemblies, the problem with solids moving through an unsealed area into the sump is exacerbated.

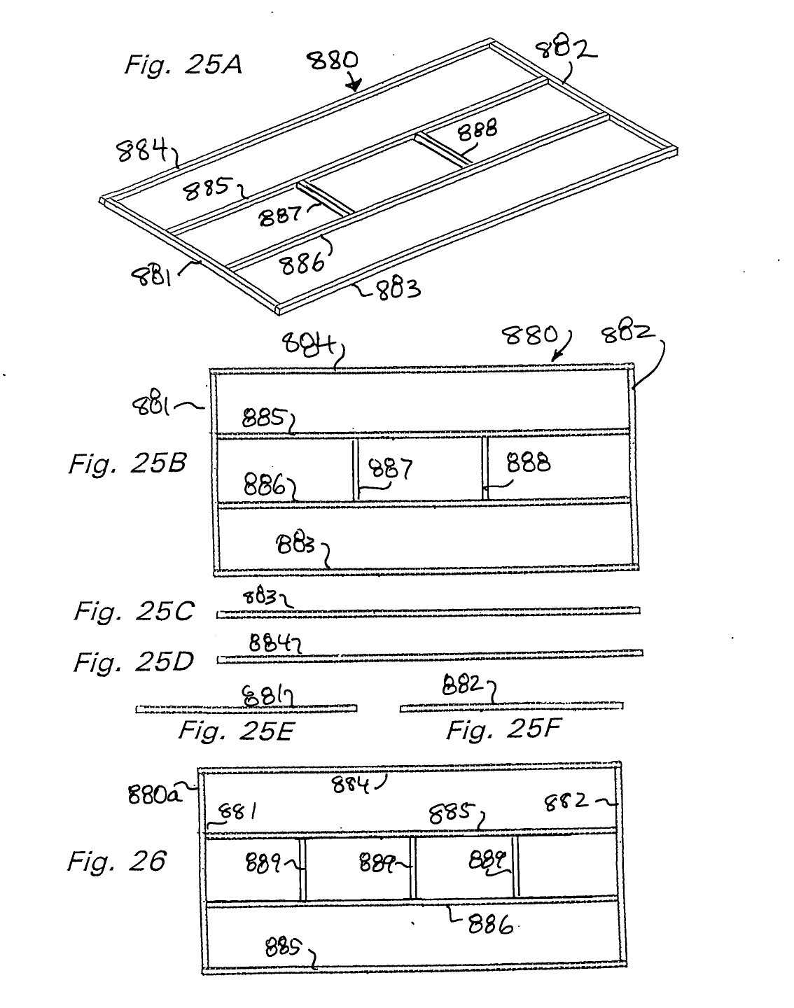

FIGS. 25A-25C show a support 880 according to the present invention for a screen assembly according to the present invention (which may have on it any screening material, plate, and/or cloth or mesh referred to or disclosed herein). The support 880 has two spaced-apart sides 881, 882 and two spaced-apart sides 883, 884 (like the sides 801 and 802 and the). Extending from the side 881 to the side 882 are two spaced-apart crossmembers 885, 886 (like the crossmembers 805, 806, FIG. 13A). There are two transverse crossmembers 887, 888 extending between the two crossmembers 885, 886. In one particular aspect all of the sides and crossmembers of the screen assembly are made from pieces of hollow mild steel with a square cross-section, a wall thickness of about one-eighth inch with a side about three-quarters of an inch long. In another aspect these pieces are solid. The pieces are, in certain aspects, connected together by any known method, including but not limited to with fasteners, adhesives, and/or welding. In one particular aspect the screen assembly 880 is made of plastic, polymer and/or composite with or without strengthening metal rods and/or fibers therein.

FIG. 26 shows an alternative design 880a of the screen assembly 880 of FIG. 25A (and like numerals indicate like parts). In the screen assembly 880a instead of the crossmembers 885, 886, there are three spaced-apart crossmembers 889 which are spaced equally apart and equally from the sides 881,882. It is within the scope of this invention to use any desired number (e.g., one, two, three, four, five, or more) of crossmembers 888 spaced as desired (e.g., but not limited to, equally as shown or with any desire spacing from the sides or between each other).

It has been discovered that elimination of all of the vertical (as viewed in FIG. 52) crossmembers from the prior art support depicted there, except those shown in FIG. 25A or those shown in FIG. 13A, e.g., renders the support sufficiently flexible to enhance the sealing of the sides 883, 884 against a seal and/or part of a screen member mounting structure bed, or deck of a vibratory separator or shale shaker.

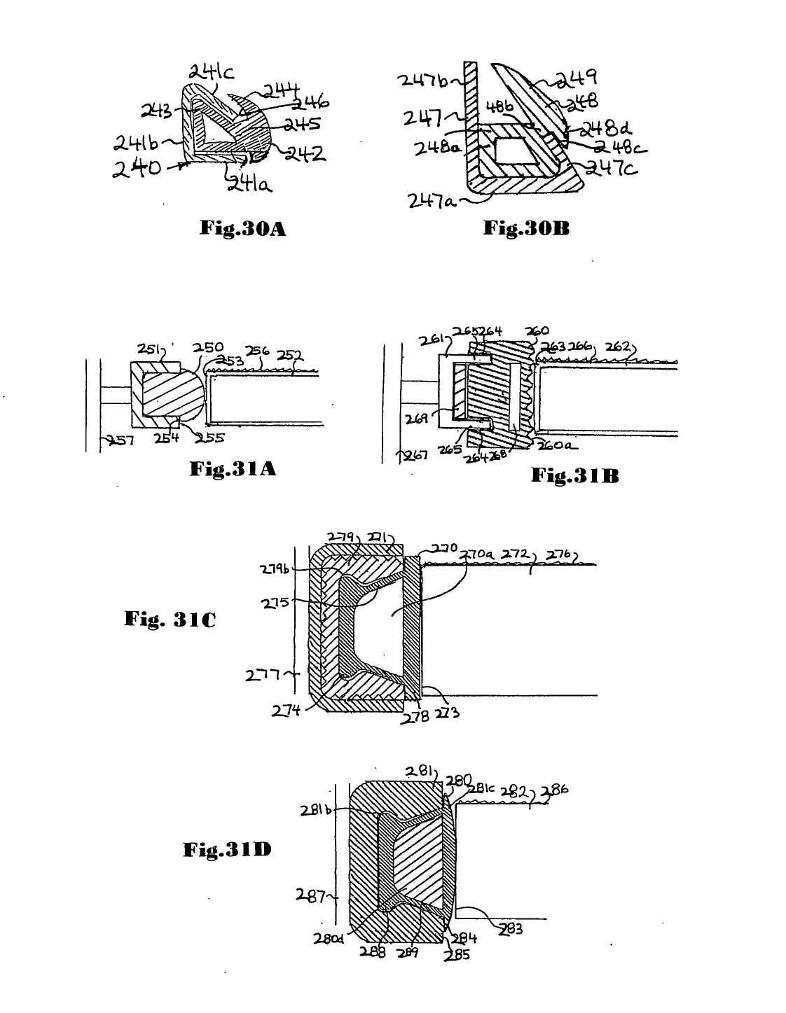

FIG. 30A shows a seal holder 240 according to the present invention which has a lower part 241a, an upright part 241b, and a top part 241c projecting downwardly. A seal 242 has a body 243 releasably and removably disposed in an interior space of the seal holder 240. Optionally, the body 243 is hollow as shown (or it may be solid). A lip 244 is connected to or formed integrally of a projecting part 245. The projecting part 246 is connected to or formed integrally of the body 243. The seal holder 240 can be used in a vibratory separator or shale shaker. Preferably the shape of the interior space of the seal holder 240 and of the body 243 of the seal 242 are substantially the same. The lip 244 is optional. Preferably the seal 242 is flexible to enhance its sealing effect against the end of a screen assembly. The top part 241c of the seal holder 240 projects into a recess 246 formed between the lip 244 and the body 243 of the seal 242. This assists in maintaining the seal 242 in a desired position with respect to the end of a screen assembly.

FIG. 30B shows a seal holder 247 according to the present invention which has a lower part 247a, an upright part 247b, and an inclined part 247c projecting upwardly. A seal 248 has a body 248a releasably and removably disposed in an interior area of the seal holder 247. Optionally, the body 248a is hollow as shown (or it may be solid). A lip 249 is connected to or formed integrally of a projecting part 248b. The projecting part 248b is connected to or formed integrally of the body 248a. The seal holder 247 can be used in a vibratory separator or shale shaker as the seal holder 22. Preferably the shape of the interior space of the seal holder 247 and of the major portion of the body 248a of the seal 247 are substantially the same. The lip 249 is optional. Preferably the seal 282 is flexible to enhance its sealing effect against the end of a screen assembly. The inclined part 247c of the seal holder 247 projects into a recess 248c formed between a lower part 248d of the lip 249 and the body 248a of the seal 248. This assists in maintaining the seal 248 in a desired position with respect to the end of a screen assembly. In one aspect the lip 249 is flexible with respect to the projecting part 248b and can move backwardly (to the left in FIG. 30B) to accommodate a screen assembly end and/or to enhance sealing contact therewith.

It is within the scope of this invention for a screen assembly with a seal structure according to the present invention (as is the case for any of the screen assemblies disclosed herein) to be any known screen assembly that abuts an end, side, or surface of a vibratory separator or shaker; and for the screening material to be any known screening material of one or more layers, with or without support, with or without layers connected together, which are generally flat or undulating.

FIG. 29A shows a seal 320 (similar to the seal 260 described above) secured to a screen assembly support part 321. Optionally, the seal 320 has a void space 322 which enhances seal/screen deck contact and, also optionally, a corrugated surface 324 for contacting a surface for sealing. Any seal structure according to the present invention may be made of any suitable plastic, metal, rubber, composite, fiberglass, alloy or seal material.

FIG. 29B shows a seal 330 (similar to the seal 280 described above) secured to a screen assembly support 332. The seal 330 has a lip 334 for abutting a surface to be sealed against. A wall 335 connects the lip 334 to a base part 336 of the seal 330. Optionally a void space 337 extends throughout the length of the seal 330 to enhance flexibility. Any seal or seal member according to the present invention may have a void space like the void space 337 of a cross-sectional shape similar to or different than that of the void space 337 (e.g., oval, circular, square).

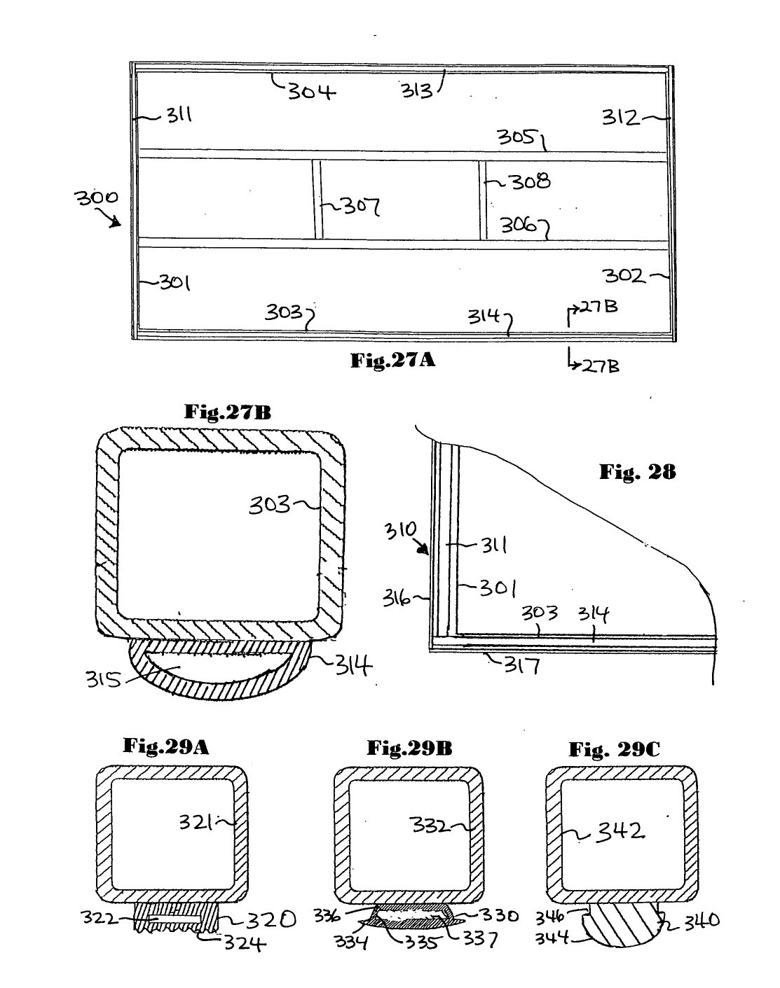

FIGS. 27A and 27B show a screen assembly support 300 according to the present invention which has two ends 301, 302 spaced apart by two sides 303, 304. Two optional spaced-apart crossmembers 305, 306 extend between the two ends 301, 302 and two optional spaced-apart crossmembers 307, 308 extend between the crossmembers 305, 306. The ends, sides, and/or crossmembers may be solid or they may be hollow. As shown in FIG. 27B a side 303 is a hollow tubular member as is commonly used in supports for screen assemblies for vibratory separators and shale shakers.

As shown in FIG. 27A seal members 311-314 are affixed to bottom surfaces of the ends 301, 302 and the sides 303, 304 to seal an interface between a screen assembly with a support 300 and a deck or mounting surface of a vibratory separator or shale shaker. Optionally, either the seal members 311, 312 or the seal members 313, 314 are deleted. Any suitable seal members, including any seal disclosed herein according to the present invention, may be used for the seals 311-314; and, as shown in FIG. 27B, in one aspect the seal 314 is “D” shaped with a hollow interior 315 which facilitates flexing of the seal to enhance sealing against a shaker deck or other screen mount or support. In one aspect the seals are made of nitrile material.

As shown in FIG. 28 a screen support 310 (or any support according to the present invention) may have exterior seals around its periphery like the seals 316, 317 shown on an end 301 and a side 303 (shown partially; seals extend completely around support). As with the bottom seals 311-314, any pair of two of the peripheral seals may be deleted. The seals 316, 317 may be solid or hollow with any shape shown or referred to herein.

FIG. 29C shows a seal 340 on a support part 342. The seal 340 has a hemispherically-shaped head 344 projecting from a base 346.

A seal like the seals 311-314 on the screen support 300 helps inhibit unscreened fluids from flowing beneath a screen assembly and a shaker deck (or other mount or screen assembly support). The seals also prevent a metal screen support from directly contacting a metal screen mounting structure, reducing metal-to-metal wear. Any suitable fasteners, connectors and/or adhesives or glues may be used to secure a seal according to the present invention to a frame or screen support. In one particular aspect LOCTITE (trademark) adhesives are used to adhere the seals to a screen support.

FIG. 31A shows a seal 250 removably mounted in a seal holder 251 with a screen assembly 252 (shown schematically) having an end 253 sealingly contacting the seal 250. The seal 250 has a lip 254 that abuts an exterior surface 255 of the seal holder 251. The screen assembly 252 has screening material 256. The seal 250 is of a length substantially equal to or slightly larger than a length of the end 253. The seal holder 251 is secured to, connected to, or formed integrally of a side wall 257 of a basket or other screen supporting structure of a separator or shaker.

FIG. 31B shows a seal 260 removably mounted to a seal holder 261 with a screen assembly 262 (shown schematically) having an end 263 sealingly contacting the seal 260. The seal 260 has a recesses 264 that receive portions 265 of the seal holder 261. The screen assembly 262 has screening material 266. The seal 260 is of a length substantially equal to or slightly larger than a length of the end 263. The seal holder 261 is secured to, connected to, or formed integrally of a side wall 267 of a basket or other screen supporting structure of a separator or shaker. Optionally, the seal 260 has a void space 268 which enhances seal/screen assembly contact and, also optionally, a corrugated surface 260a for contacting the screen end 263. Optionally a member 269 may be permanently or removably positioned within the seal holder 261 to serve as a space maintainer, shock absorber, cushion, and/or seal and may be made of any suitable plastic, metal, composite, fiberglass, alloy or seal material.

FIG. 31C shows a seal 270 removably mounted in a seal holder 271 with a screen assembly 272 (shown schematically) having an end 273 sealingly contacting the seal 270. The seal 270 has a lip 274 that abuts a surface 275 of a seal holder 279. The seal holder 279 is removably or permanently positioned within a seal holder 271. The screen assembly 272 has screening material 276. The seal 270 is of a length substantially equal to or slightly larger than a length of the end 273. The seal holder 271 is secured to, connected to, or formed integrally of a side wall 277 of a basket or other screen supporting structure of a separator or shaker. The seal holder 279 may be made of any material mentioned above for the member 269. Optionally the seal holder 279 may have a corrugated outer surface 279a to facilitate its movement within the seal holder 271. A recess 279b receives a lip 274 of the seal 270. A wall 275 connects the lip 274 to an outer part 278 of the seal 270. Optionally, the seal 270 has an inner void space 270a.

FIG. 31D shows a seal 280 removably mounted in a seal holder 281 with a screen assembly 282 (shown schematically) having an end 283 sealingly contacting the seal 280. The seal 280 has a lip 284 that abuts an exterior surface 285 of the seal holder 281. The screen assembly 282 has screening material 286. The seal 280 is of a length substantially equal to or slightly larger than a length of the end 283. The seal holder 281 is secured to, connected to, or formed integrally of a side wall 287 of a basket or other screen supporting structure of a separator or shaker. A recess 281b receives a lip 288 of the seal 280. A wall 289 connects the lip 281b to an outer part 281c of the seal 280. A rigid member 280d extends throughout the length of the seal 280 to provide strength and rigidity.

Any seal or seal member according in any embodiment of the present invention may have a rigid member like the rigid member 280d of a cross-sectional shape similar to or different than that of the rigid member 80d (e.g., oval, circular, square).

The seal holders of FIGS. 31A-31D have a length corresponding to the length of the seals mounted therein or thereto (e.g. slightly shorter, slightly larger or similar to that of the seals)

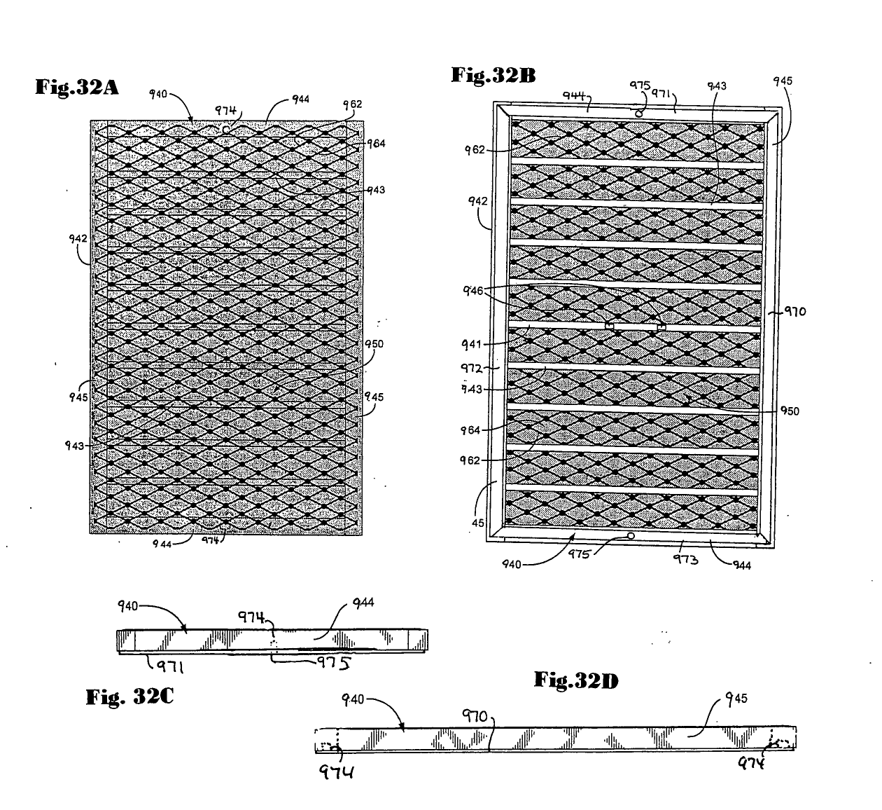

FIGS. 32A-32F show a screen assembly 940 according to the present invention which has a tubular frame 942 with ends 944 and interconnected sides 945. A screening material layer or combination of layers 950 is secured to the tubular frame 942, e.g. with glue, adhesive, epoxy, and/or fasteners. An optional crossmember 941 (of a plurality of optional spaced-apart crossmembers 943 that extend between and have ends connected to the sides 945) has two optional notches 946, either of which is for receiving a portion of an upstanding member of a shale shaker deck. As shown in FIG. 32B, the frame 942 is surrounded with seal members 970-973 which are secured to the frame 942 with any suitable glue, adhesive, epoxy, and/or fasteners. In one aspect the seal members 970-973 are hollow with a general “D” shape with the flat part of the “D” adhered to the frame 942, in one particular aspect, with LOCTITE (trademark) brand commercially available adhesives, e.g. LOCTITE (trademark), TAK PAK (trademark) adhesives, PRISM (trademark) adhesives, or SUPER BONDER (trademark) adhesives; and, in one particular aspect, the seal members 970-973 are made of Nitrile material (which can withstand the heat and chemical composition of drilling materials pumped from a wellbore).

As shown in FIGS. 32A-32D, optionally the seal members 971, 973 have holes 975 corresponding to and aligned with holes 974 in the frame 942 (holes 974 shown in dotted lines in FIGS. 32A, 32C, 32D). The holes 974, 975 are sized, configured and located for receiving an upwardly projecting member projecting upwardly from a screen mounting structure or deck of a shaker or vibratory separator. Optionally, one of the holes 974 is deleted.

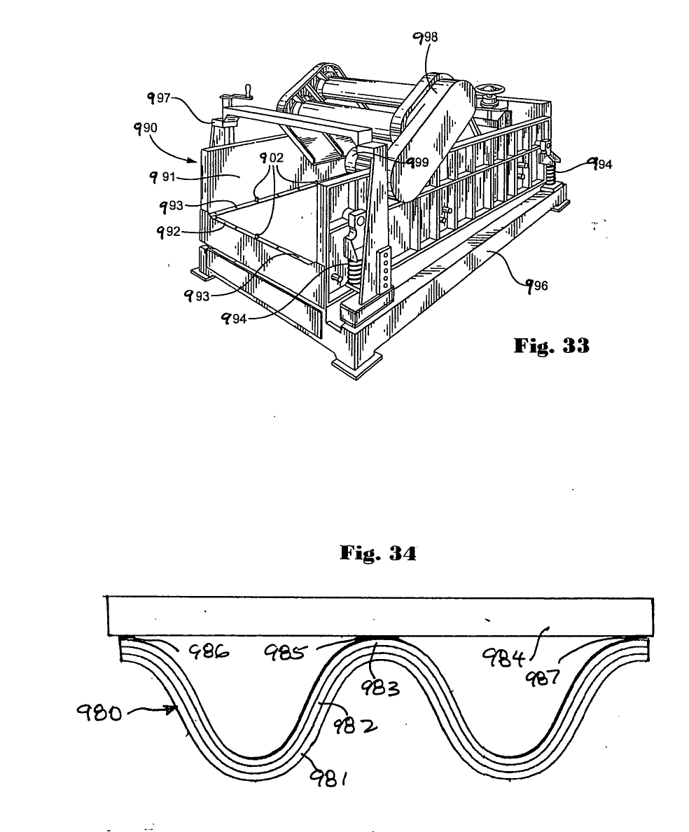

FIG. 33 shows a shale shaker 990 with a plurality of spaced-apart upwardly projecting members 902 projecting up from a deck 992. It is to be-understood, although not shown, that as desired, upstanding members 902 may be provided spaced-apart on both sides or around the entire periphery of the deck 992 (or of any vibratory separator or shaker deck). Optionally, holes 993 may be deleted or they may be provided and sized for receiving downwardly projecting members of a screen assembly. In one particular aspect the upstanding members 902 are sized and located for receipt within holes like the holes 974, 975 of the screen assembly 940, FIGS. 32A-32D. Optionally, only one upstanding member 902 is provided for each screen assembly.

Thus it is seen, e.g. as shown in FIGS. 32A-33, that the present invention provides a screen assembly for releasable mounting to a mounting structure of a vibratory separator or shale shaker, the mounting structure with a body over which a screen assembly is positionable, part of material to be treated flowable through the body, at least one upwardly projecting member projecting upwardly from the body, the at least one upwardly projecting member sized and configured so it is receivable in a corresponding hole in the screen assembly, the at least one projecting member having a projecting member cross-sectional area, the screen assembly having a support (e.g. a frame); screening material on the support (e.g. one, two, three or more layers); the support two spaced-apart ends, the two spaced-apart ends spaced-apart by two spaced-apart sides, each of the two spaced-apart sides connected to each of the two spaced-apart ends, optionally one or a plurality of spaced-apart crossmembers extending between the two spaced-apart sides from one side to the other side, at least part of the support being a tubular member with a top and a bottom, a portion of the screening material over the tubular member; at least one hole in the bottom of the tubular member, the at least one hole sized, configured, and located for receiving the at least one upwardly projecting member of the body of the mounting structure, the at least one hole having a hole cross-sectional area greater than the projecting member cross-sectional area.

Thus it is also seen, e.g. as shown in FIGS. 32A-33, that the present invention provides a shale shaker system for separating components of drilling fluid with solids entrained therein, the shale shaker system having a base; a screen mounting basket on the base; vibrating apparatus connected to the screen mounting basket for vibrating the screen mounting basket; the screen mounting basket having mounting structure for at least one screen assembly mounted on the mounting structure, the mounting structure having a body over which the at least one screen assembly is positionable, part of the drilling fluid to be treated by the shale shaker flowable through the at least one screen assembly and through the body; at least one screen assembly mounted on the mounting structure; the at least one screen assembly releasably mounted to the mounting structure of a shale shaker; the mounting structure having at least one upwardly projecting member projecting upwardly from the body, the at least one upwardly projecting member sized and configured so it is receivable in a corresponding hole in the screen assembly; the at least one projecting member having a projecting member cross-sectional area; the at least one screen assembly including a support; screening material on the support; the support being a frame with two spaced-apart ends, the two spaced-apart ends spaced-apart by two spaced-apart sides, each of the two spaced-apart sides connected to each of the two spaced-apart ends, the frame optionally having one or a plurality of spaced-apart crossmembers extending between the two spaced-apart sides from one side to the other side, at least part of the frame being a tubular member with a top and a bottom, a portion of the screening material on top of the tubular member; and at least one hole in the bottom of the tubular member, the at least one hole sized, configured, and located for receiving said at least one upwardly projecting member of the body of the mounting structure, the at least one hole having a hole cross-sectional area greater than the projecting member cross-sectional area.

FIG. 34 shows a seal member 980 according to the present invention which may be used in place of or in combination with any seal or seal member disclosed herein for sealing a support/mounting-structure interface. The seal member 980 has a corrugated structure (as viewed in cross-section in FIG. 34) and, according to the present invention, such a seal member may have any desired member of ridges and valleys. In one aspect, the seal member 980 is made of a single sealing material; but, as shown, the seal member has multiple layers 981-983. In one aspect these layers are of differing flexibilities with the layer 981 most flexible, the layer 982 less flexible, and the layer 983 least flexible. Optionally, any one or two layers are deleted. Adhesive, glue, or epoxy 985-987 secures the seal member 980 to a frame member 984.

The present invention discloses, in at least certain embodiments, a screen assembly for mounting on mounting structure of a vibratory separator, the screen assembly having a frame with a first frame end spaced apart from a second frame end by two opposed spaced-apart sides including a first side and a second side, the frame having a top and a bottom, the frame abutting the mounting structure at a mounting-structure/frame interface, screening material on the frame, and seal apparatus on the bottom of the frame for sealing the mounting-structure/frame interface.

Such a screen assembly may have one or some, in any possible combination of the following: the seal apparatus is a plurality of seal members, at least one of the plurality of seal members positioned along each frame side and each frame end; each seal member of the plurality of seal members has a body with an interior space extending along the entire body; the body is generally “D” shaped (hollow or solid) including a generally flat side, the generally flat side secured to the frame; each seal member of the plurality of seal members is a solid body; each seal member has a body secured to the frame and a lip projecting from the body; the seal apparatus is a plurality of seal members with an inner shape corresponding to part of an outer shape of a frame end or side, the seal members affixed to the frame with said part of the outer shape positioned within said inner shape; the frame has a recessed portion and part of the seal apparatus is positioned within said recessed portion; a plurality of crossmembers spaced apart and extending from the first side to the second side, each crossmember of the plurality of crossmembers connected to the first side and the second side, and each crossmember of the plurality of crossmembers having at least one series of openings therethrough; each crossmember having a length and the at least one series of openings extending along substantially all of said length; the screening material is a plurality of superimposed layers of screening material; the plurality of layers of screening material are connected together and are connected to the frame; and/or wherein the frame sides and ends have a length and the seal apparatus extends along substantially the entire length of the sides and ends.

The present invention discloses, in at least certain embodiments, a screen assembly for mounting on mounting structure of a vibratory separator, the screen assembly having a frame with a first frame end spaced apart from a second frame end by two opposed spaced-apart sides including a first side and a second side, the frame having a top and a bottom, the frame abutting the mounting structure at a mounting-structure/frame interface, screening material on the frame, seal apparatus on the bottom of the frame for sealing the mounting-structure/frame interface, the seal apparatus having a plurality of seal members, at least one of the plurality of seal members positioned along each frame side and each frame end, each seal member of the plurality of seal members has a body with an interior space extending along the entire body, wherein the screening material is a plurality of superimposed layers of screening material, and wherein the frame sides and ends have a length and the seal apparatus extends along substantially the entire length of the sides and ends.

The present invention discloses, in at least certain embodiments, a vibratory separator for treating material introduced thereto, the vibratory separator having screen assembly holding apparatus, vibration apparatus for vibrating a screen assembly on the screen assembly holding apparatus, and at least one screen assembly on the screen assembly holding apparatus, the at least one screen assembly as any disclosed herein according to the present invention.

The present invention discloses, in at least certain embodiments, a method for treating material with a vibratory separator, the method including introducing material to be treated to a vibratory separator, the vibratory separator as any disclosed herein according to the present invention.

The present invention discloses, in at least certain embodiments, a screen assembly for releasable mounting to a mounting structure of a shale shaker, the mounting structure having a body over which a screen assembly is positionable, part of fluid to be treated by the shale shaker flowable through the body, at least one upwardly projecting member projecting upwardly from the body, said at least one upwardly projecting member sized and configured so it is receivable in a corresponding hole in the screen assembly, said at least one projecting member having a projecting member cross-sectional area, the screen assembly having a support, screening material on the support, the support having a frame with two spaced-apart ends, the two spaced-apart ends spaced-apart by two spaced-apart sides, each of the two spaced-apart sides connected to each of the two spaced-apart ends, the frame abutting the mounting structure at a mounting-structure/frame interface, the frame having a plurality of spaced-apart crossmembers extending between the two spaced-apart sides from one side to the other side, at least part of the frame is a tubular member with a top and a bottom, a portion of the screening material on top of the tubular member, at least one hole in the bottom of the tubular member, said at least one hole sized, configured, and located for receiving said at least one upwardly projecting member of the body of the mounting structure, said at least one hole having a hole cross-sectional area greater than said projecting member cross-sectional area, and seal apparatus on the bottom of the frame for sealing the mounting-structure/frame interface; and such a screen assembly wherein the seal apparatus is a plurality of seal members, at least one of the plurality of seal members positioned along each frame side and each frame end, and wherein the frame sides and ends have a length and the seal apparatus extends along substantially the entire length of the sides and ends.

The present invention discloses, in at least certain embodiments, a shale shaker system for separating components of drilling fluid with solids entrained therein, the shale shaker system having a base, a screen mounting basket on the base, vibrating apparatus connected to the screen mounting basket for vibrating the screen mounting basket, the screen mounting basket having mounting structure for at least one screen assembly mounted on the mounting structure, the mounting structure having a body over which the at least one screen assembly is positionable, part of the drilling fluid to be treated by the shale shaker flowable through the at least one screen assembly and through the body, at least one screen assembly according to the present invention mounted on the mounting structure, the mounting structure having at least one upwardly projecting member projecting upwardly from the body, the at least one upwardly projecting member sized and configured so it is receivable in a corresponding hole in the screen assembly, the at least one projecting member having a projecting member cross-sectional area, the at least one screen assembly including a support, screening material on the support, the support having a frame with two spaced-apart ends, the two spaced-apart ends spaced-apart by two spaced-apart sides, each of the two spaced-apart sides connected to each of the two spaced-apart ends, the frame abutting the mounting structure at a mounting-structure/frame interface, the frame having a plurality of spaced-apart crossmembers extending between the two spaced-apart sides from one side to the other side, at least part of the frame having a tubular member with a top and a bottom, a portion of the screening material on top of the tubular member, and at least one hole in the bottom of the tubular member, said at least one hole sized, configured, and located for receiving the at least one upwardly projecting member of the body of the mounting structure, the at least one hole having a hole cross-sectional area greater than said projecting member cross-sectional area, and seal apparatus on the bottom of the frame for sealing the mounting-structure/frame interface; and such a shaker wherein the seal apparatus is a plurality of seal members, at least one of the plurality of seal members positioned along each frame side and each frame end, and wherein the frame sides and ends have a length and the seal apparatus extends along substantially the entire length of the sides and ends.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form it may be utilized. The invention claimed herein is new and novel in accordance with 35 U.S.C. § 102 and satisfies the conditions for patentability in § 102. The invention claimed herein is not obvious in accordance with 35 U.S.C. § 103 and satisfies the conditions for patentability in § 103. This specification and the claims that follow are in accordance with all of the requirements of 35 U.S.C. § 112. The inventor may rely on the Doctrine of Equivalents to determine and assess the scope of their invention and of the claims that follow as they may pertain to apparatus not materially departing from, but outside of, the literal scope of the invention as set forth in the following claims. Any and all patents or patent applications referred to by number herein is incorporated fully herein for all purposes.

1. A screen assembly for mounting on mounting structure of a vibratory separator, the screen assembly comprising
a frame with a first frame end spaced apart from a second frame end by two opposed spaced-apart sides including a first side and a second side, the frame having a top and a bottom, the frame abutting the mounting structure at a mounting-structure/frame interface,
screening material on the frame, and
seal apparatus on the bottom of the frame for sealing the mounting-structure/frame interface.

2. The screen assembly of claim 1 wherein
the seal apparatus comprises a plurality of seal members, at least one of the plurality of seal members positioned along each frame side and each frame end.

3. The screen assembly of claim 2 wherein
each seal member of the plurality of seal members has a body with an interior space extending along the entire body.

4. The screen assembly of claim 3 wherein
the body is generally “D” shaped including a generally flat side, the generally flat side secured to the frame.

5. The screen assembly of claim 2 wherein
each seal member of the plurality of seal members is a solid body.

6. The screen assembly of claim 2 wherein
each seal member has a body secured to the frame and a lip projecting from the body.

7. The screen assembly of claim 1 wherein
the seal apparatus comprises seal members with an inner shape corresponding to part of an outer shape of a frame end or side, the seal members affixed to the frame with said part of the outer shape positioned within said inner shape.

8. The screen assembly of claim 1 wherein
the frame has a recessed portion and part of the seal apparatus is positioned within said recessed portion.

9. The screen assembly of claim 1 further comprising
a plurality of crossmembers spaced apart and extending from the first side to the second side, each crossmember of the plurality of crossmembers connected to the first side and the second side, and
each crossmember of the plurality of crossmembers having at least one series of openings therethrough.

10. The screen assembly of claim 9 wherein each crossmember has a length and the at least one series of openings extending along substantially all of said length.

11. The screen assembly of claim 1 wherein the screening material is a plurality of superimposed layers of screening material.

12. The screen assembly of claim 11 wherein the plurality of layers of screening material are connected together and are connected to the frame.

13. The screen assembly of claim 1 wherein the frame sides and ends have a length and the seal apparatus extends along substantially the entire length of the sides and ends.

14. A screen assembly for mounting on mounting structure of a vibratory separator, the screen assembly comprising
a frame with a first frame end spaced apart from a second frame end by two opposed spaced-apart sides including a first side and a second side, the frame having a top and a bottom, the frame abutting the mounting structure at a mounting-structure/frame interface,
screening material on the frame,
seal apparatus on the bottom of the frame for sealing the mounting-structure/frame interface,
the seal apparatus comprising a plurality of seal members, at least one of the plurality of seal members positioned along each frame side and each frame end,
each seal member of the plurality of seal members has a body with an interior space extending along the entire body,
wherein the screening material is a plurality of superimposed layers of screening material, and
wherein the frame sides and ends have a length and the seal apparatus extends along substantially the entire length of the sides and ends.

15. A vibratory separator for treating material introduced thereto, the vibratory separator comprising
screen assembly holding apparatus,
vibration apparatus for vibrating a screen assembly on the screen assembly holding apparatus, and
at least one screen assembly on the screen assembly holding apparatus, the at least one screen assembly comprising a frame with a first frame end spaced apart from a second frame end by two opposed spaced-apart sides including a first side and a second side, screening material on the frame having at least one series of openings therethrough, the frame having a top and a bottom, and seal apparatus in the bottom of the frame for sealing a screen-assembly-holding-apparatus/screen-assembly interface.

16. A method for treating material with a vibratory separator, the method comprising
introducing material to be treated to a vibratory separator, the vibratory separator comprising
screen assembly holding apparatus,
vibration apparatus for vibrating a screen assembly on the screen assembly holding apparatus, and
at least one screen assembly on the screen assembly holding apparatus the at least one screen assembly comprising a frame with a first frame end spaced apart from a second frame end by two opposed spaced-apart sides including a first side and a second side, screening material on the frame having at least one series of openings therethrough, the frame having a top and a bottom, and seal apparatus in the bottom of the frame for sealing a screen-assembly-holding-apparatus/screen-assembly interface.

17. A screen assembly for releasable mounting to a mounting structure of a shale shaker, the mounting structure comprising a body over which a screen assembly is positionable, part of fluid to be treated by the shale shaker flowable through the body, at least one upwardly projecting member projecting upwardly from the body, said at least one upwardly projecting member sized and configured so it is receivable in a corresponding hole in the screen assembly, said at least one projecting member having a projecting member cross-sectional area, the screen assembly comprising
a support,
screening material on the support,
the support comprising a frame with two spaced-apart ends, the two spaced-apart ends spaced-apart by two spaced-apart sides, each of the two spaced-apart sides connected to each of the two spaced-apart ends, the frame abutting the mounting structure at a mounting-structure/frame interface, the frame having a plurality of spaced-apart crossmembers extending between the two spaced-apart sides from one side to the other side, at least part of the frame comprising a tubular member with a top and a bottom, a portion of the screening material on top of the tubular member,
at least one hole in the bottom of the tubular member, said at least one hole sized, configured, and located for receiving said at least one upwardly projecting member of the body of the mounting structure, said at least one hole having a hole cross-sectional area greater than said projecting member cross-sectional area, and
seal apparatus on the bottom of the frame for sealing the mounting-structure/frame interface.

18. The screen assembly of claim 17 wherein
the seal apparatus comprises a plurality of seal members, at least one of the plurality of seal members positioned along each frame side and each frame end, and
wherein the frame sides and ends have a length and the seal apparatus extends along substantially the entire length of the sides and ends.

19. A shale shaker system for separating components of drilling fluid with solids entrained therein, the shale shaker system comprising
a base,
a screen mounting basket on the base,
vibrating apparatus connected to the screen mounting basket for vibrating the screen mounting basket,
the screen mounting basket comprising mounting structure for at least one screen assembly mounted on the mounting structure, the mounting structure comprising a body over which the at least one screen assembly is positionable, part of the drilling fluid to be treated by the shale shaker flowable through the at least one screen assembly and through the body,
at least one screen assembly mounted on the mounting structure,
the at least one screen assembly comprising a screen assembly for releasable mounting to the mounting structure of a shale shaker,
the mounting structure having at least one upwardly projecting member projecting upwardly from the body, said at least one upwardly projecting member sized and configured so it is receivable in a corresponding hole in the screen assembly, said at least one projecting member having a projecting member cross-sectional area,
the at least one screen assembly including
a support,
screening material on the support,
the support comprising a frame with two spaced-apart ends, the two spaced-apart ends spaced-apart by two spaced-apart sides, each of the two spaced-apart sides connected to each of the two spaced-apart ends, the frame abutting the mounting structure at a mounting-structure/frame interface, the frame having a plurality of spaced-apart crossmembers extending between the two spaced-apart sides from one side to the other side, at least part of the frame comprising a tubular member with a top and a bottom, a portion of the screening material on top of the tubular member, and
at least one hole in the bottom of the tubular member, said at least one hole sized, configured, and located for receiving said at least one upwardly projecting member of the body of the mounting structure, said at least one hole having a hole cross-sectional area greater than said projecting member cross-sectional area, and
seal apparatus on the bottom of the frame for sealing the mounting-structure/frame interface.

20. The shale shaker system of claim 19 wherein
the seal apparatus comprises a plurality of seal members, at least one of the plurality of seal members positioned along each frame side and each frame end, and
wherein the frame sides and ends have a length and the seal apparatus extends along substantially the entire length of the sides and ends.
